(19) United States
(12) Patent Application Publication
(10) Pub. No.: US 2026/0204597 A1
(43) Pub. Date: Jul. 16, 2026

(54) SINGLE CELL OF A FUEL CELL AND ASSOCIATED FUEL CELL

(71) Applicant: SYMBIO FRANCE, Saint-Fons (FR)

(72) Inventors: Didier BELIN, VINCENNES (FR); Thibaut DEJARDIN, Courpalay (FR)

(21) Appl. No.: 19/137,876

(22) PCT Filed: Dec. 13, 2023
(86) PCT No.: PCT/EP2023/085538

§ 371 Date: Jun. 11, 2025

(30) Foreign Application Priority Data
Dec. 14, 2022 (FR) FR2213370

(51) Int. Cl. H01M 8/0273; H01M 8/0258; H01M 8/0284

(52) U.S. Cl. CPC H01M 8/0273; H01M 8/0258; H01M 8/0284

(57) ABSTRACT

The invention relates to a single cell (100) of a fuel cell stack, which comprises a plurality of walls (102), that are each continuous and sealed, which define compartments (V100) of the single cell and which are held by a sealing structure (200). The sealing structure is formed of a stack of wall frames (220), which each surround an associated wall (102), compartment frames (230), which are each arranged at the periphery of a corresponding compartment (V100), and adhesive layers (240), which are inserted between each of the frames of the sealing structure so as to sealingly secure the frames to each other. Each wall forms, with its associated wall frame, a peripheral gap, which is sealingly closed, on at least one of the faces of this wall, by a compartment frame arranged opposite this peripheral gap.

The present invention relates to a single cell of a fuel cell as well as to a fuel cell comprising such a single cell.

A fuel cell is a device that generates electricity through an electrochemical reaction between a fuel, such as di-hydrogen—also simply called hydrogen—and an oxidant, such as di-oxygen—also simply called oxygen—contained in the air. We are interested herein in proton exchange membrane fuel cells—also called PEMFC—with a solid electrolyte which usually comprise a stack of single cells, each forming an electrochemical generator.

Schematically expressed, each single cell comprises two separators, also called bipolar plates, in-between which a solid electrolyte in the form of a proton exchange membrane is interposed. The membrane is made e.g. of a perfluorinated sulfonated polymer material. Within each cell, each separator delimits a reactive compartment with the corresponding membrane. One of the two reactive compartments houses a cathodic element, whereas the other reactive compartment houses an anodic element.

Within the stack, the cells are stacked so as to alternate cathodic and anodic elements. In many types of fuel cells, for two neighboring cells, a separator of one of the two cells is back-to-back with a separator of the other cell. The two separators together form a bipolar separator, also called a bipolar plate. A cooling compartment, wherein a cooling fluid such as glycolated water circulates, is generally arranged in-between the two separators of the bipolar separator. In other types of fuel cells, in particular in a cell without liquid cooling, the same separator is shared by two neighboring cells, and thus the cell does not include a cooling compartment.

Hydrogen, air, and any cooling liquid are so-called “working fluids” which are supplied to the fuel cell during the operation thereof. Depending on the operating phases of the fuel cell, the supply of one or a plurality of the working fluids takes place continuously or intermittently.

The fuel cell thereby provides openings in order to supply fluids to each of the reactive compartments and the fluids between two neighboring cells. Thereby, each bipolar separator provides on one side the supply of fuel to the cell adjacent to sais side and on the other side the supply of oxidant to the cell adjacent to the other side, with the supplies provided by the bipolar separators taking place in parallel.

When the fuel cell is in operation, the electrochemical reaction creates a difference of electrical potential between the two separators of each single cell. The fuel cell thereby comprises an electrical isolation device, designed to prevent the leaks of current between two neighboring cells and between each cell and the external environment, as well as a sealing device for preventing leaks of working fluids, in particular for preventing the fluid circulating in one reactive compartment from contaminating a neighboring reactive compartment.

EP-3 618 157-A1 describes, e.g., a redox cell, the fuel and oxidant of which are electrolytes, i.e. liquids. The redox cell comprises frames, which are made of polypropylene and are arranged around the bipolar plates and electrodes, so as to reduce leaks of current. The frames are pierced to provide circulation channels for the electrolytes. Sealing is provided by O-rings, which are placed in grooves machined into the thickness of the frames and are held in compression by a clamping flange. Such a structure is not suitable for the passage of gaseous fluids, in particular air or hydrogen, used with a fuel cell. Furthermore, the fitting and the checking of each seal are tedious operations.

JP-5 330 135-B2 describes a single cell of a fuel cell comprising a sealing structure composed of frames and L-shaped separators, the frames and separators being stacked and assembled by adhesive elements. Passages between the manifolds and the internal compartments of the single cell are recessed in the L-shaped separators, which requires a specific machining step and complicates the assembly of the sealing structure.

The invention aims to address more particularly the above problems by proposing a fuel cell stack that is easy to assemble and provides both good electrical isolation and good sealing.

To this end, the invention relates to a single cell of a fuel cell stack, wherein:
the single cell comprises a plurality of walls, each of which is continuous and sealed and stacked on top of each other along a axis of stacking, the walls delimiting compartments of the single cell and including:
   a first separator,
   a second separator, and
   a proton exchange membrane, which is interposed between the first separator and the second separator,
the first separator delimits with the membrane a first reactive compartment, the first reactive compartment being configured to receive a first working fluid of the fuel cell,
the second separator delimits with the membrane a second reactive compartment, the second reactive compartment being configured to receive a second working fluid of the fuel cell,
the compartments of the single cell include the first reactive compartment and the second reactive compartment,
the cell further comprises a sealing structure, the sealing structure comprising frames, each made of a polymer material and stacked along the axis of stacking, the frames being arranged around the periphery of the walls and of the compartments.

According to the invention, for at least one of the compartments of the single cell, and for at least one of the two walls delimiting the at least one compartment:
-the frames of the sealing structure include:
   a wall frame, which is coplanar with the corresponding wall and surrounds the wall, an internal edge of each wall frame being arranged opposite an external edge of the wall, the internal edge of the wall frame and the external edge of the wall being opposite each other and separated by a peripheral gap, each wall frame preferentially having a thickness substantially equal to a thickness of the corresponding wall,
   a compartment frame, which is arranged around the periphery of the corresponding compartment, the compartment frame comprising an internal edge, which is oriented towards the corresponding compartment and delimits the compartment radially to the axis of stacking, and an external edge, opposite the internal edge, the internal edge having an internal contour, whereas the external edge has an external contour,
   layers of adhesives, which are each interposed between, on the one hand, a compartment frame, and, on the other hand, the wall and the wall frame adjacent to the compartment frame, so as to attach, in a sealed manner, the frames to each other,
the internal contour of the compartment frame is included, in projection along the axis of stacking, in an external contour of the wall, so that an annular portion of the wall faces, along the axis of stacking, a mating portion of the compartment frame and forms a first overlap of the compartment frame on the wall,
an internal contour of the wall frame is included, in projection along the axis of stacking, in the external contour of the compartment frame, so that an annular portion of the wall frame faces a mating portion of the compartment frame and forms a second overlap of the compartment frame on the wall frame,
the layers of adhesive include a first portion of the layer, which extends opposite the first overlap between the compartment frame and the adjacent wall, so as to attach, in a sealed manner, the compartment frame to the wall, and
the layers of adhesives include a second portion of the layer, which extends opposite the second overlap between the compartment frame and the adjacent wall frame, so as to attach, in a sealed manner, the compartment frame to the wall frame.

By means of the invention, the frames of the sealing structure are assembled to each other using the layers of adhesives, making the assembly of the single cell practical and quick to produce. Furthermore, as the first compartment frame has an internal contour included in the external contour of the membrane, the first portion of the layer of adhesive, interposed between the internal face of the first compartment frame and the external face of the adjacent membrane, prevents leaks of the working fluid circulating in the first reactive compartment towards the second reactive compartment. Similarly, as the internal contour of the first compartment frame is included in the external contour of the first separator, the second portion of the layer of adhesive, interposed between the internal face of the first compartment frame and the external face of the adjacent separator, prevents the leaks towards the cooling compartment. The first and second portions of the layers of adhesives provide sealing over the entire overlapping surfaces, preventing the passage of both liquid and gaseous working fluids, between the elements assembled by the layers of adhesives. Furthermore, it is possible to use repositionable and/or pressure-sensitive layers of adhesives, allowing for a removable cell to be proposed.

According to advantageous but non-mandatory aspects of the invention, such a single cell may incorporate one or a plurality of the following features taken individually or in any technically permissible combination:
the first separator is configured to separate in a sealed manner the first reactive compartment from a first cooling compartment, which is configured to receive a third working fluid of the fuel cell, whereas the compartments of the single cell include, in addition to the first reactive compartment and to the second reactive compartment, the first cooling compartment.
The first portion of the layer of adhesive and the second portion of the layer of adhesive I are part of the same layer of adhesive, which extends continuously over one face of the compartment frame, to seal the peripheral gap adjacent to the compartment frame.
The first overlap has a leak length, which is equal to a minimum distance, measured parallel to the median plane, between any two points belonging to the internal edge of the corresponding compartment frame and to the external edge of the adjacent corresponding wall, respectively, whereas the second overlap has a leak length, which is equal to a minimum distance, measured parallel to the median plane, between any two points belonging to the external edge of the corresponding compartment frame and to the internal edge of the adjacent corresponding wall frame, respectively and each leak length is greater than or equal to 1 mm, preferably greater than or equal to 2 mm, else preferably greater than or equal to 3 mm.
For at least one of the compartment frames:
   the compartment frame includes a transfer frame that provides two passages for fluids, the two passages being intended for the circulation of the associated working fluid between the corresponding compartment and the outside of the single cell,
   each passage opens into the associated compartment through an internal mouth, which is provided on the internal edge of the transfer frame, and
   each passage opens to the outside of the compartment through an external mouth.
Each passage comprises an internal portion, which opens through the internal mouth into the compartment, the internal portion of the passage being provided in the thickness of the transfer frame.
The external mouth is provided on the external edge of the transfer frame.
For at least one transfer frame:
   at least one of the two passages houses guide fins for the associated working fluid,
   the fins are formed by cutting the transfer frame and are spaced apart within the corresponding passage, so as to direct the flow of the associated working fluid,
   the fins are held by means of the layers of adhesives in-between which the corresponding transfer frame is interposed.
For at least one of the first and second reactive compartments, the compartment frame comprises:
   the transfer frame,
   a first sealing frame, which is interposed in-between, on the one hand, the transfer frame and, on the other hand, a first of the two walls adjacent to the compartment frame and the wall frame opposite the first wall,
   a first adhesive film, which is interposed between the first sealing frame and the transfer frame, whereas the first sealing frame is, on the one hand, attached to the first wall and the opposite wall frame by the adhesive layer associated with the first wall and, on the other hand, fixed to the transfer frame by the first adhesive film.
The compartment frame comprises, in addition to the first sealing frame:
   a second sealing frame, the first and second sealing frames being arranged on either side of the transfer frame, the second sealing frame being interposed in-between, on the one hand, the transfer frame and, on the other hand, a second of the two walls adjacent to the compartment frame and the wall frame associated with the second wall, the second wall being different from the first wall,
   a second adhesive film, which is interposed in-between the second sealing frame and the transfer frame,
whereas the second sealing frame is, on the one hand, attached to the second wall and the opposite wall frame by the corresponding adhesive layer and, on the other hand, attached to the transfer frame by the second film of adhesive.
For at least one sealing frame, the adhesive film associated with the sealing frame is continuously coated on one face of the sealing frame.
For at least one sealing frame:
   the sealing frame is made of a polymer material, e.g. PET, and has a thickness, measured parallel to the axis of stacking, comprised between 10 μm and 20 μm, preferably equal to 12 μm,
   the film of adhesive interposed between the sealing frame and the corresponding transfer frame has a thickness, measured parallel to the axis of stacking, comprised between 6 μm and 30 μm, preferably comprised between 8 μm and 20 μm, preferably comprised between 10 μm and 15 μm.
For each compartment of the single cell and for each of the walls delimiting the compartment, the peripheral gap associated with the wall is sealed, on at least one of the faces of the wall, by a sealing frame.
For at least one transfer frame:
   the transfer frame is made of a polymer material, e.g., PET, and has a thickness, measured parallel to the axis of stacking, comprised between 50 μm and 200 μm, preferably comprised between 80 μm and 150 μm, preferably equal to 100 μm,
   each of the first portion of the layer of adhesive and each of the second portions of the layer of adhesive has a thickness, measured parallel to the axis of stacking, between 15 μm and 30 μm, preferably between 18 μm and 25 μm, preferably equal to 20 μm.

The invention further relates to a fuel cell, comprising a stack formed of a plurality of single cells stacked along the axis of stacking, each single cell being according to any of the preceding claims, and a sleeve, which provides an internal volume wherein the stack is housed, wherein:
the frames of the sealing structure of each single cell each have their own external edge, with an associated external contour,
the external contours of all the frames of each sealing structure are superimposed on each other along the axis of stacking, the external edges of all the frames of all the sealing structures together forming an external surface of the stack, which has a cylindrical shape centered on the axis of stacking,
the external surface of the stack provides holding members, which are configured to cooperate with mating members provided in the internal volume of the sleeve, so as to maintain the stack within the internal volume and to provide a peripheral volume between the stack and the sleeve, and
the holding and the mating members are designed to divide the peripheral volume into a plurality of circulation conduits for the working fluids of the fuel cell.

Advantageously:
for each compartment of each single cell, the associated compartment frame includes a transfer frame that provides two passages for fluids, the two passages being intended for the circulation of the associated working fluid between the corresponding compartment and the outside of the single cell,
while each passage opens into the associated compartment through an internal mouth, which is provided on the internal edge of the transfer frame,
and each passage opens to the outside of the compartment through an external mouth.
The external mouth is provided on the external edge of the transfer frame, while:
   the fuel cell provides two first pairs of circulation conduits, which are associated with the first and second working fluids, respectively, of the fuel cell, the single cells being as defined hereinabove,
   for each single cell:
      each of the two compartments chosen from the first reactive compartment and the second reactive compartment is associated with a respective pair of the first conduits,
      the compartment frames associated with each of the two reactive compartments of the single cell each comprise a transfer frame with two passages each, the external mouth of each passage being provided on an external edge of the corresponding transfer frame,
      the two passages of the same transfer frame each open into a distinct conduit among the two circulation conduits of the associated pair.
For each single cell, the first separator is configured to separate in a sealed manner the first reactive compartment from a first cooling compartment, which is configured to receive a third working fluid of the fuel cell, while the fuel cell provides, in addition to the two first pairs of circulation conduits, a third pair of circulation conduits, the circulation conduits of the third pair being associated with the third working fluid, while for each single cell:
   each of the three compartments chosen from the first reactive compartment, the second reactive compartment, and the first cooling compartment is associated with a respective pair among the three pairs of conduits,
   the compartment frames associated with each of the three compartments of the single cell each comprise a transfer frame with two passages each, the external mouth of each passage being provided on an external edge of the corresponding transfer frame,
   the two passages of the same transfer frame each open into a distinct conduit among the two circulation conduits of the associated pair.

The invention will be better understood, and other advantages thereof will become more apparent in light of the following description of an embodiment of a single cell and of a fuel cell, according to the principle thereof, given solely as an example and with reference to the enclosed drawings, wherein:

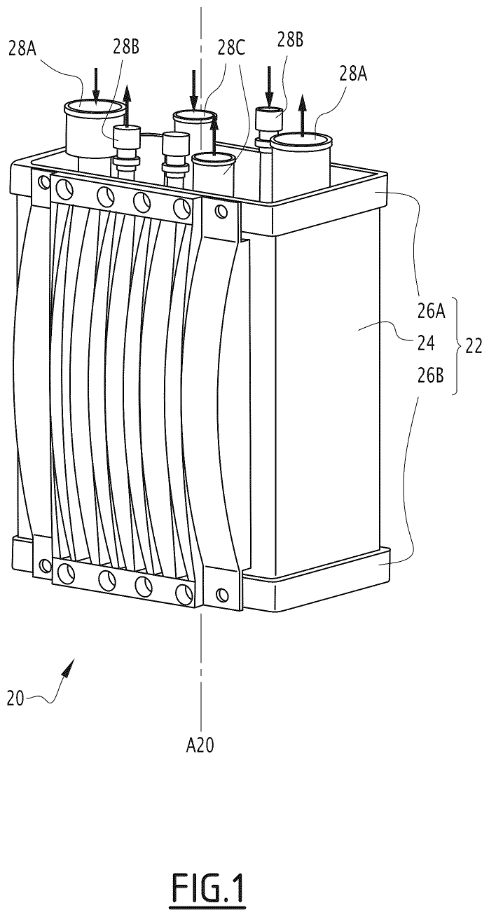

FIG. 1 is a perspective view of a fuel cell according to the invention;

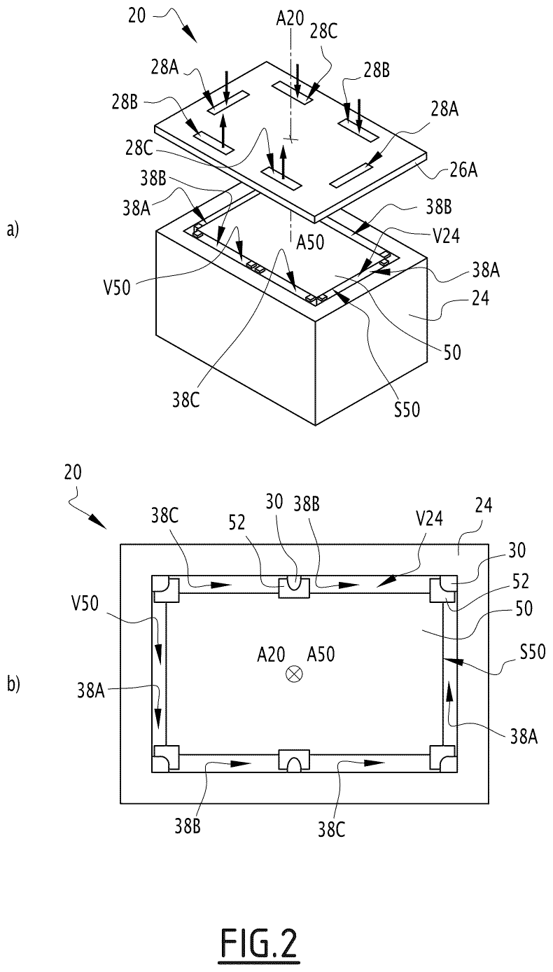

FIG. 2 shows, in two inserts a) and b), two schematic views of the fuel cell shown in FIG. 1, observed in a partially exploded perspective and in a top view, some parts being hidden;

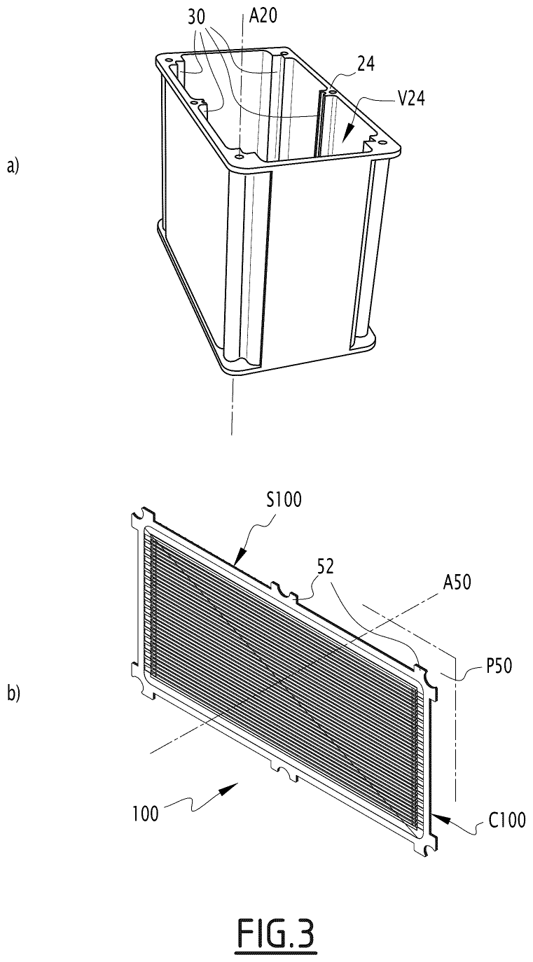

FIG. 3 shows, in two inserts a) and b), a sleeve and a single cell, respectively, of the fuel cell shown in FIG. 1, the single cell being according to an embodiment;

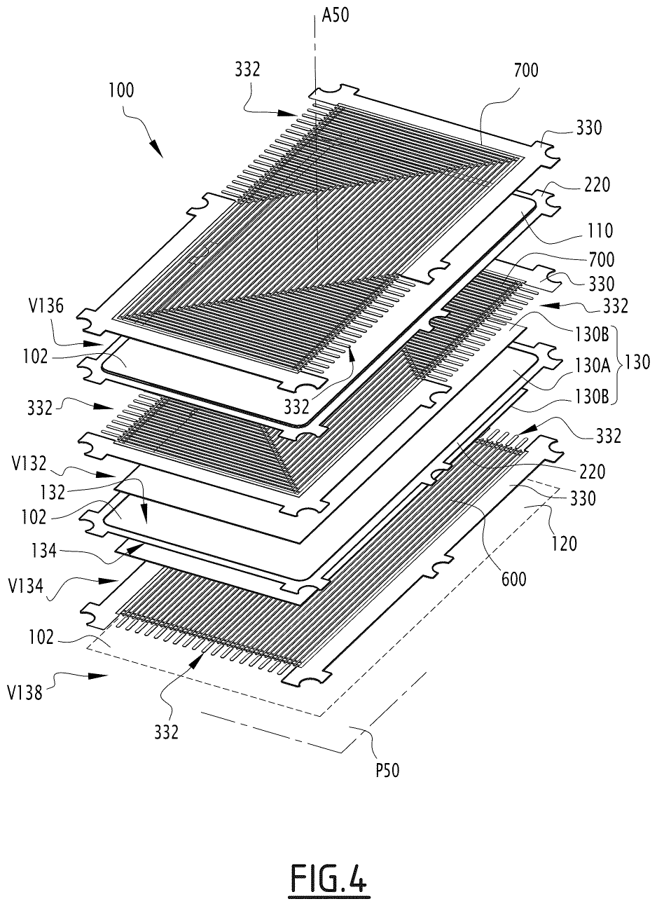

FIG. 4 is an exploded perspective view of the single cell shown in FIG. 3, some parts being hidden;

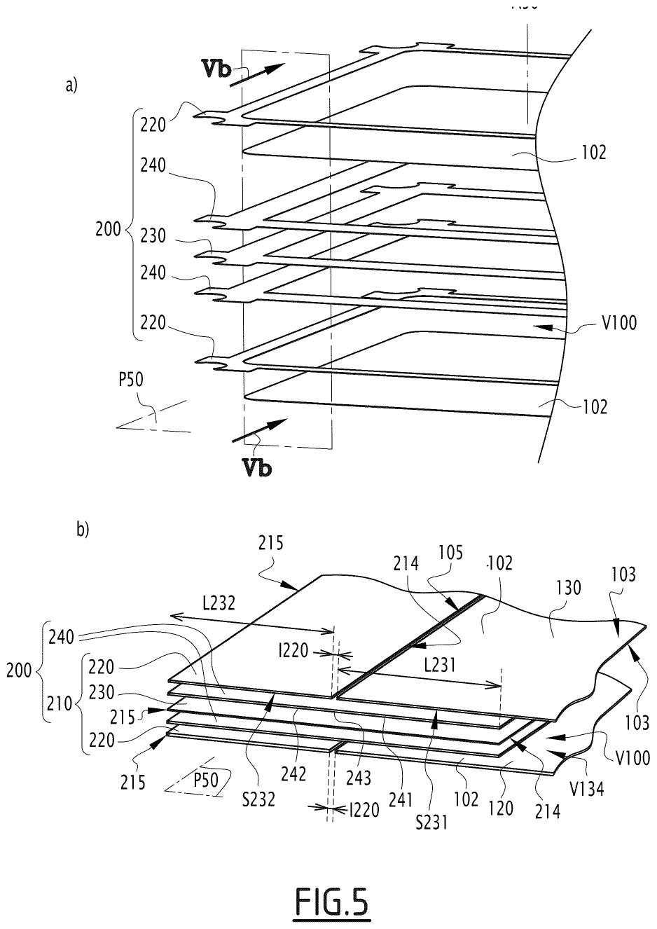

FIG. 5 shows, in two inserts a) and b), a partial and exploded perspective of a first compartment of the single cell of FIG. 3, observed at two different scales and in section on insert b);

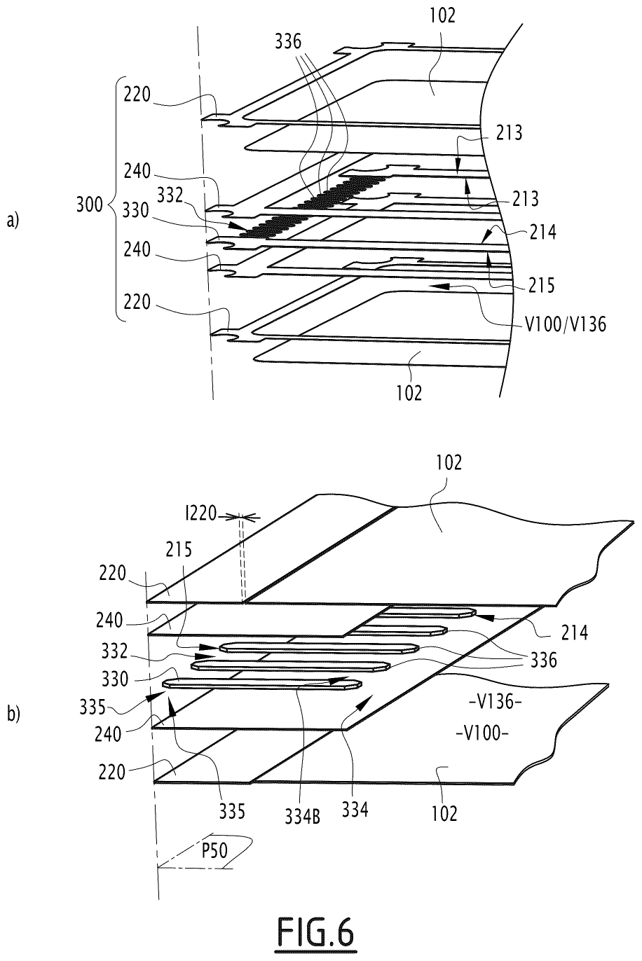

FIG. 6 shows, in two inserts a) and b), a partial and exploded perspective of a single cell according to another embodiment, observed at two different scales and in section on insert b);

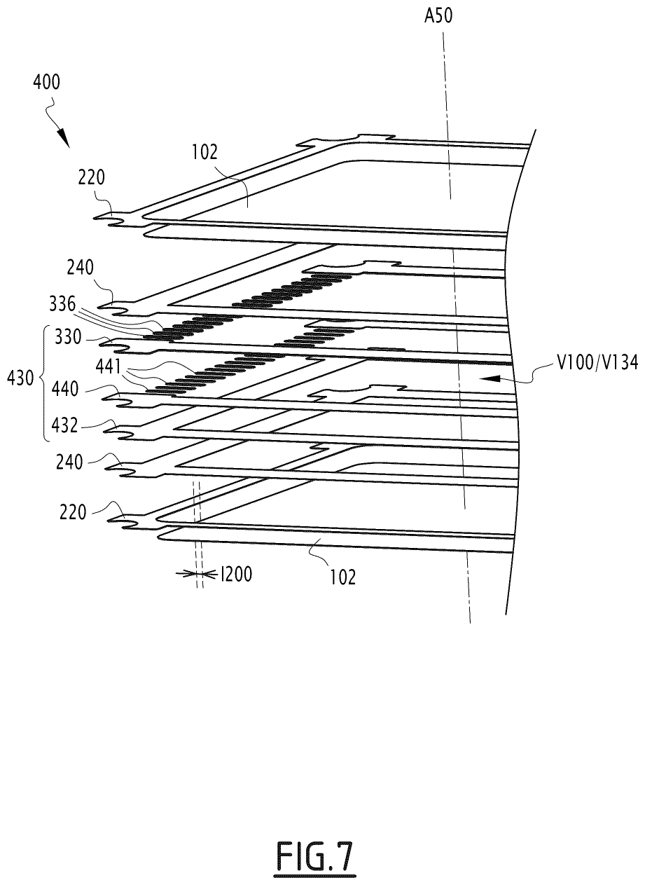

FIG. 7 shows an exploded and partial perspective of a single cell according to another embodiment;

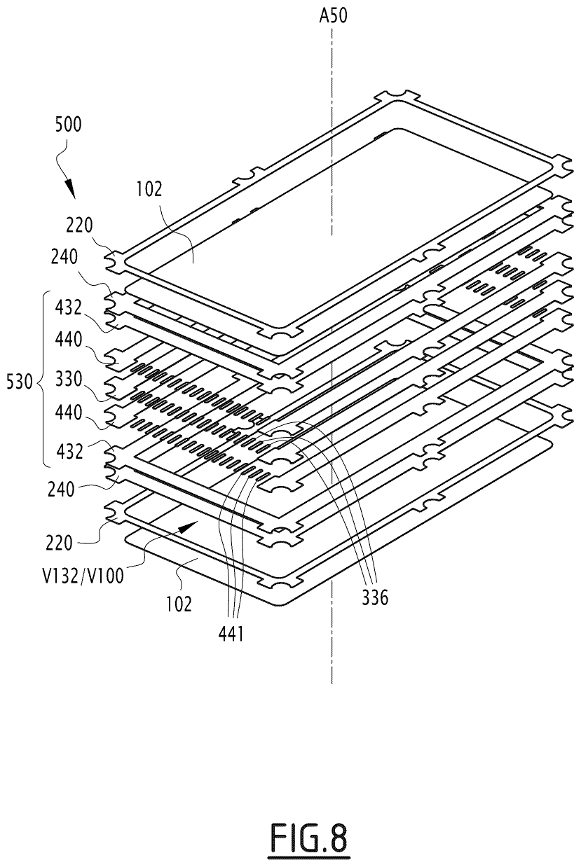

FIG. 8 shows a partial and exploded perspective of a second compartment of the single cell shown in FIG. 3;

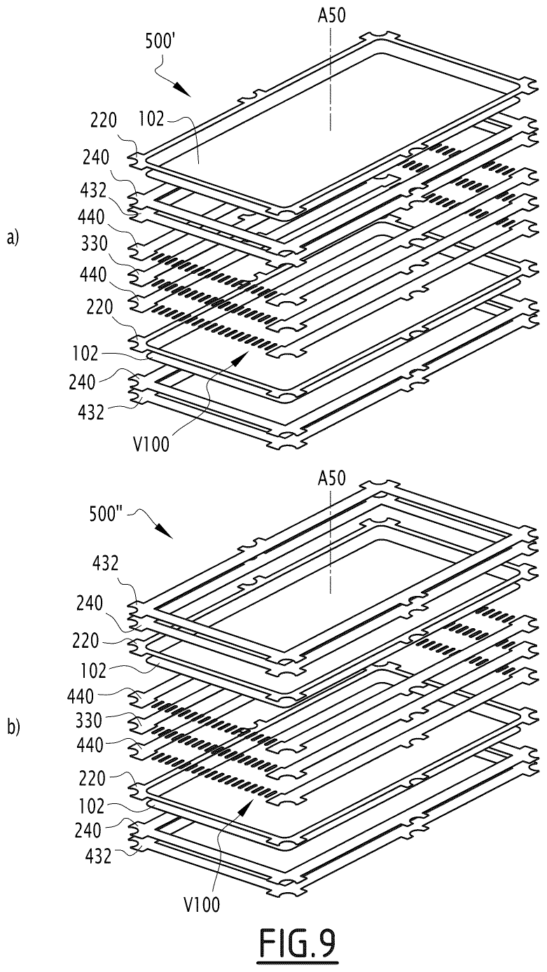

FIG. 9 shows, in two inserts a) and b), a partial and exploded perspective, respectively, of a single cell according to two other embodiments of the invention;

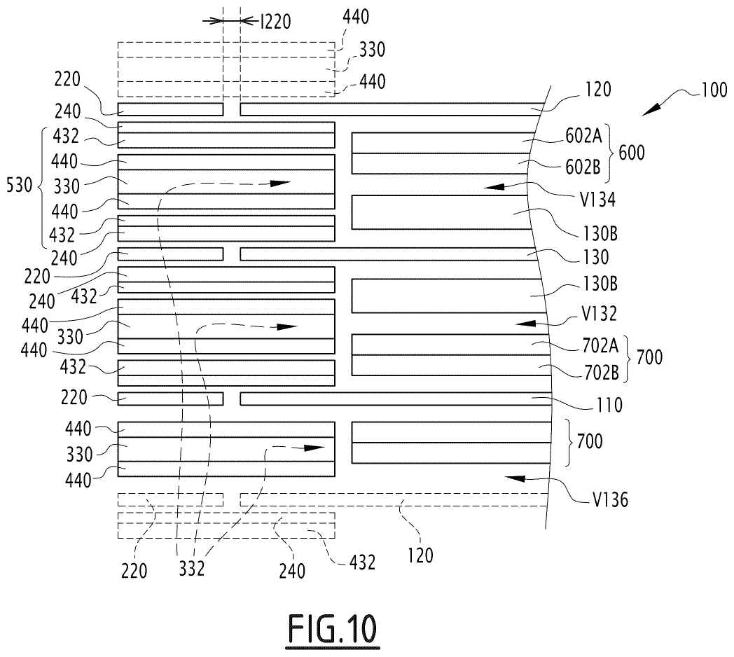

FIG. 10 shows, schematically, a partial cross-section of an embodiment of the single cell shown in FIG. 3;

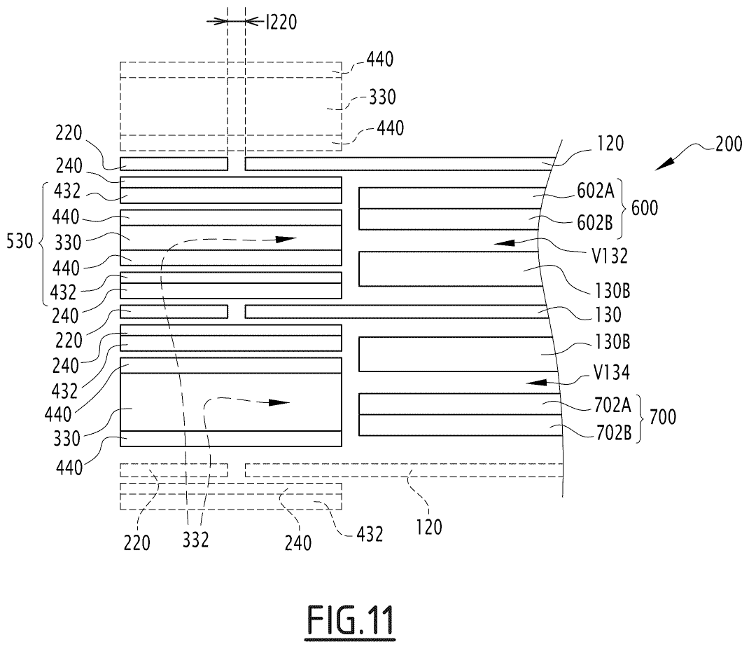

FIG. 11 shows, schematically, a partial cross-section of a single cell according to another embodiment;

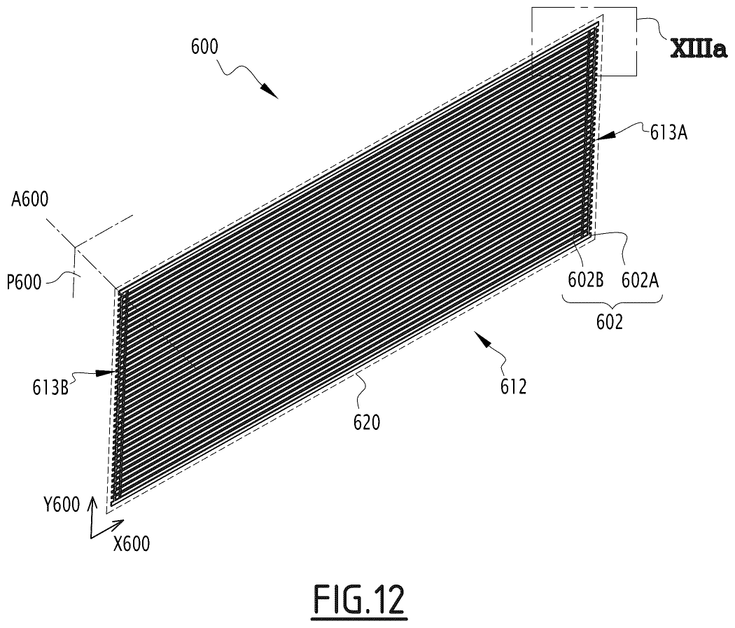

FIG. 12 is a perspective view of a first irrigation spacer of the single cell shown in FIG. 3;

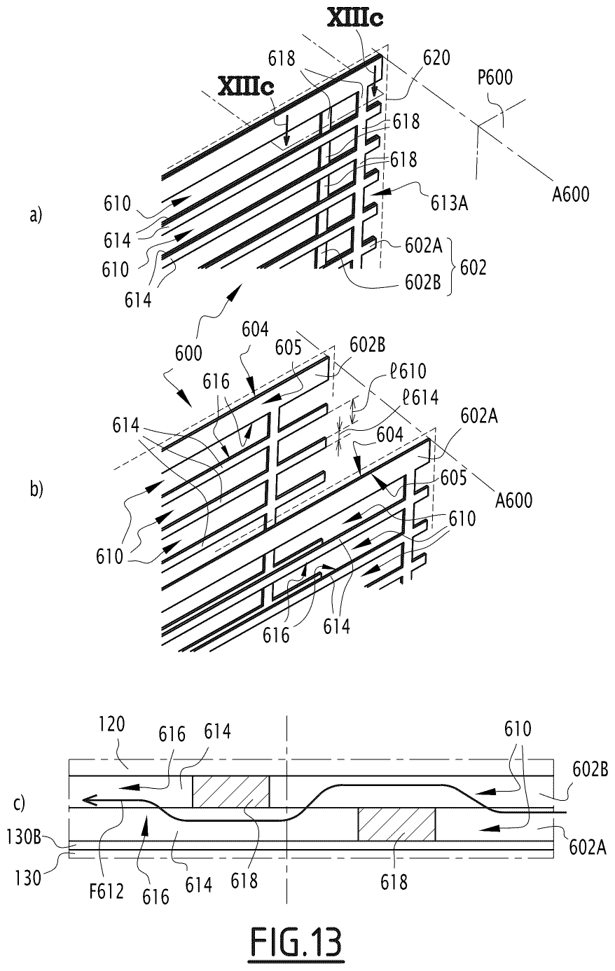

FIG. 13 correspondingly shows, in three inserts a), b), and c), a detail XIIIa of the irrigation spacer shown in FIG. 12, the same detail observed in exploded perspective and a diagram illustrating a principle of operation of the irrigation spacer shown in FIG. 12;

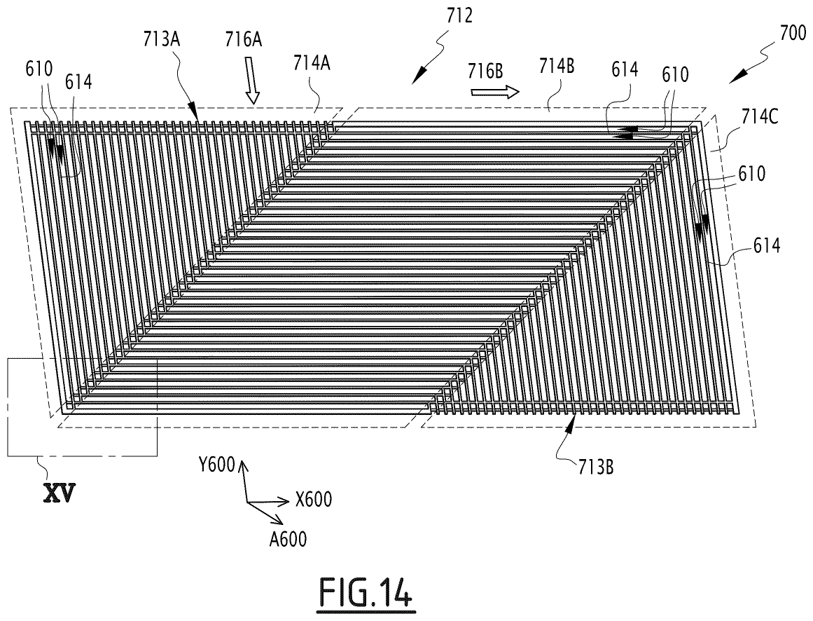

FIG. 14 is a perspective view of a second irrigation spacer of the single cell shown in FIG. 3; and

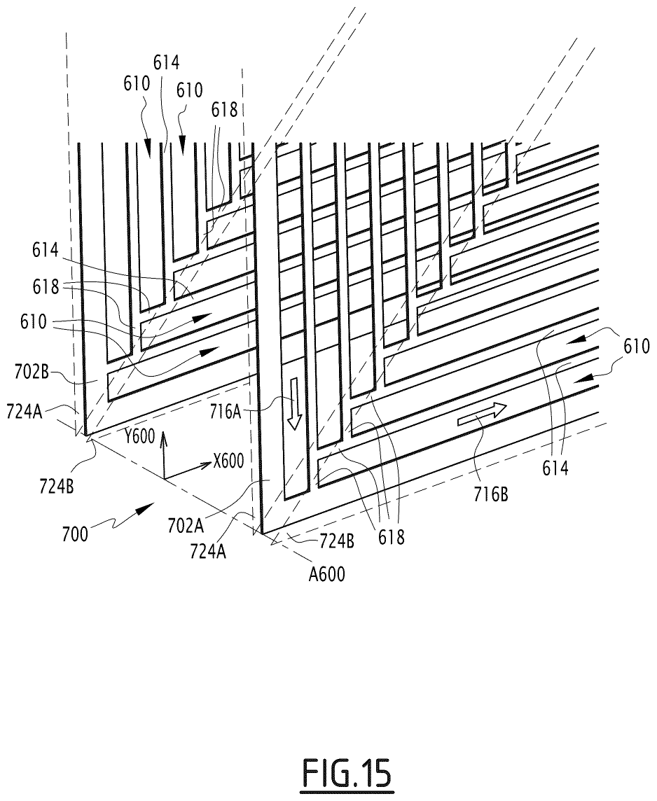

FIG. 15 is an exploded perspective view at a larger scale of a detail XV of FIG. 14.

A fuel cell 20 is shown in FIG. 1. The fuel cell 20, also simply called “cell 20” hereinafter, comprises a housing 22, which includes a sleeve 24. The sleeve 24 has a hollow cylindrical shape, which extends along a cell axis A20 and herein has a substantially rectangular section. The sleeve 24 provides an internal volume V24 with two opposite openings, the openings being closed by two covers 26A and 26B. The sleeve 24 and the covers 26A and 26B are preferably made of electrically insulating material, such as a polymer material or a fiber-reinforced polymer material, or are coated, at least on an internal face, with an electrically insulating material.

Fluidic conduits are provided through the housing 22 for letting through working fluids of the cell 20. The working fluids herein comprise three fluids, thus two gaseous fluids, herein air and di-hydrogen, and a dielectric heat transfer fluid, e.g. a liquid, herein glycolated water. The fluidic conduits are embodied by fluidic fittings, which are provided herein on the cover 26A, located at the top of FIGS. 1 and 2. Alternatively, all or part of the fluidic fittings is provided on the cover 26B. Alternatively, all or part of the fluidic fittings is installed on the sleeve 24.

The cell 20 thereby comprises three pairs of fluidic fittings, each pair being intended for the circulation of a specific working fluid. The three pairs of fluidic fittings include a first pair of fittings 28A, a second pair of fittings 28B, and a third pair of fittings 28C. For each pair of fittings, one of the fittings, called the “inlet fitting,” is intended for the intake of the corresponding working fluid, whereas the other fitting, called the “outlet fitting,” is intended for the extraction of the corresponding working fluid. In the figures, the direction of circulation of the working fluids is schematically represented by arrows oriented arbitrarily, knowing that the direction may be other in reality.

In FIG. 2, the cell 20 is schematically shown in exploded perspective, with the cover 26A being moved away from the sleeve 24. The fittings 28A, 28B, and 28C are schematically represented by openings passing through the cover 26A. The sleeve 24 is shown in isolation in FIG. 3a).

The internal volume V24 of the sleeve 24 houses a stack 50. The stack 50 comprises an external surface S50, which has the shape of a cylinder centered on a axis of stacking A50 and with a generally rectangular section. When the stack 50 is received in the internal volume V24, the axis of stacking A50 coincides with the cell axis A20.

The stack 50 is formed of a plurality of single cells 100, which are stacked along the axis of stacking A50. A single cell 100 is shown in isolation in FIG. 3b), and in exploded perspective in FIG. 4. Each single cell 100 has a flattened shape, which extends along a median plane P50 orthogonal to the axis of stacking A50. In other words, the median plane P50 is a plane transverse to the axis of stacking A50. Each single cell 100-also simply called “cell 100” hereinafter-has, in projection onto the median plane P50, an external contour C100. It is understood that the section of the external surface S50 of the stack 50 corresponds to the external contour C100 of each single cell 100.

The external surface S50 of the stack 50 provides holding members 52, which are configured to cooperate with complementary elements 30 provided in the internal volume V24 of the sleeve 24, to maintain the stack 50 within the internal volume V24 and to provide a peripheral volume V50 between the stack 50 and the sleeve 24. The peripheral volume V50 is thus a portion of the internal volume V24, which is distributed around the stack 50. The holding members 52 and the mating members 30 are provided along the external surface S50 parallel to the axis of stacking A50, and along the sleeve 24 parallel to the cell axis A20, respectively and include sealing elements, so as to divide the peripheral volume V50 into a plurality of circulation conduits for the working fluids of the fuel cell 20. Advantageously, the holding members 52 and the mating members 30 provide electrical isolation between the stack 50 and the sleeve 24.

Each circulation conduit is fluidically connected to a respective fitting 28A, 28B, or 28C, so as to ensure the circulation of the working fluids around the stack 50, and thus around each single cell 100.

The fuel cell 20 provides herein six circulation conduits, which are correspondingly associated in pairs with the three working fluids of the fuel cell. The six circulation conduits thereby include a first pair of conduits 38A, which are fluidically connected to the first pair of fittings 28A, a second pair of conduits 38B, which are fluidically connected to the second pair of fittings 28B, and a third pair of conduits 38C, which are fluidically connected to the third pair of fittings 28C.

Each circulation conduit 38A, 38B, or 38C is thereby separated in a sealed manner from the neighboring conduits. In the present description, “sealed” means sealed with regard to any of the liquid or gaseous working fluids, of the fuel cell 20, in particular sealed to hydrogen, which tends to leak the most due to the small molecular size thereof and to the low viscosity thereof compared to the other working fluids.

In the example illustrated more particularly by FIGS. 1 and 3, the sleeve 24 is thus an external wall of the cell 20, the sleeve 24 delimiting the circulation conduits 38A, 38B, or 38C wherein a fluid circulates under a pressure higher than the atmospheric pressure. Even if such pressure is generally less than 5 bars in absolute pressure, or even less than 3 bars in absolute pressure, it is necessary to take into account the difference in pressure with the atmospheric pressure prevailing outside the sleeve 24, making sure in particular that the sleeve 24 does not become deformed (in particular by bulging) to the point of compromising the sealing between the circulation conduits 38A, 38B, or 38C. In the illustrated example, to limit a deformation by bulging, in particular of the largest faces of the sleeve 24, external reinforcements are provided. In the example, the external reinforcements are independent of the sleeve 24, are thus directly mounted onto the sleeve, and are attached to the outside of the sleeve 24, each bearing on a face (herein a flat external face) of the sleeve 24. Each external reinforcement extends along the cell axis A20 between two ends. In the example, each end is attached, e.g. by screwing, to the corresponding cover 26A, 26B. Alternatively, the external reinforcement(s) is(are) attached exclusively to the sleeve 24, or are even attached on one side to the sleeve 24 and on the other side to only one of the two covers. Each external reinforcement has a central body bearing on the corresponding external face of the sleeve 24. In the illustrated example, only two external reinforcements are provided, one on each of the two opposite faces of the sleeve 24 that have the largest surface, and thus has the highest risk of deformation due to the pressure in the circulation conduits 38A, 38B, or 38C. However, external reinforcements could also be provided for each external face, in particular for each flat external face of the sleeve 24. In the illustrated example, the central body of an external reinforcement has a transverse width, along an orthoradial direction to the cell axis A20 and parallel to the corresponding external face of the sleeve 24, which is preferably greater than or equal to 50% of the transverse width of said corresponding external face onto which same bears, so that only one external reinforcement is necessary for the corresponding external face. However, for a given external face of the sleeve 24, a plurality of distinct individual reinforcements could be provided, offset from each other along the transverse direction, and thus each having small transverse width. In the illustrated example, the external reinforcement has stiffeners, herein in one piece with the central body, forming a thickening on the central body along a radial direction perpendicular to the cell axis A20 and perpendicular to the corresponding external face of the sleeve 24. Advantageously, the stiffeners have a radial thickness, along the radial direction, which changes along the direction of the cell axis A20, with a lesser radial thickness at the two ends, and conversely a greater radial thickness at the center in said direction. The stiffness of the stiffener can thereby be optimized by adapting the thickness to the constraints undergone by the sleeve 24, at different points of the latter, due to the pressure inside the conduits. The directly mounted external reinforcement(s) is(are) preferably made of metal, e.g. of aluminum or aluminum alloy, e.g. in the form of a cast part of aluminum alloy. In a variant, the directly mounted external reinforcement(s) is(are) made of polymer material, preferably then of composite material combining a polymer resin and reinforcements, e.g. in the form of glass fibers, carbon fibers, and/or aramid fibers. According to yet another variant, similar reinforcements are integrated into the sleeve 24, in other words, made in one piece with the sleeve, thus imparting the sleeve an optimized geometry for withstanding the forces due to the pressures of the fluids in the circulation conduits 38A, 38B, or 38C.

The single cells 100 of the stack 50 are preferably identical to each other. The single cell 100 will be now discussed in detail.

As illustrated in FIG. 4, the cell 100 comprises a plurality of walls 102, which are continuous and sealed and stacked on top of each other along the axis of stacking A50. The walls 102 include a first separator 110, a second separator 120, and a proton exchange membrane 130. The wall 102 formed by the membrane 130 is interposed between the first separator 110 and the second separator 120. The walls 102 delimit therebetween the compartments V 100 of the single cell 100.

Still in FIG. 4, the second separator 120 is schematically represented in dotted lines. The first separator 110 and the second separator 120 are preferably identical to each other and are produced herein by cutting a metal sheet, e.g., a stainless steel sheet.

The membrane 130, also called (in English) PEM for “Proton Exchange Membrane”, is produced herein in the form of a polymer layer 130A. Generally, on either side of the membrane 130, in each of the compartments V100 delimited by the membrane 130 on either side of same, a gas diffusion layer 130B is provided, so that the membrane 130 is sandwiched between the two gas diffusion layers 130B. The polymer layer 130A is herein made of a fluorinated polymer material, e.g., known under the commercial name Nafion.

In the illustrated example, the polymer layer 130A is coated on the two faces thereof with a catalyst layer, the membrane 130 being called (in English) CCM for “Catalyst Coated Membrane”. The catalyst layers are not shown. The membrane 130, the gas diffusion layers 130A and 130B, and the associated catalyst layers together form what is generally called MEA, an acronym in English for “Membrane Electrode Assembly.”

In an alternative not shown, at least one of the catalyst layers is deposited on one or the other of the two gas diffusion layers 130B, between the gas diffusion layer 130B and the adjacent polymer layer 130A.

The polymer layer 130A is sealed to the reactive gases, hydrogen or oxygen, but permits therethrough the diffusion of protons H+. The gas diffusion layers 130B, also called (in English) GDL, are porous to reactive gases and are, for the most part, made of entangled and compressed carbon fibers. The gas diffusion layers 130B may be coated, if appropriate, on the face thereof in contact with the membrane 130A with an ionomer that may be of the same nature as the material of the polymer layer 130A. The structure of the membrane 130 is not discussed in detail thereafter.

The membrane 130 comprises a first face 132 and a second face 134 opposite the first face 132. The first face 132 and the second face 134 extend parallel to the median plane P50. The first face 132 is oriented towards the first separator 110. The first separator 110 delimits with the membrane 130 a first reactive compartment V132, which is configured to receive a first working fluid of the fuel cell 20. Herein, the first reactive compartment V132 is e.g. an anodic compartment of the single cell 100, meaning that the first working fluid is hydrogen. Thus, the first working fluid is a gaseous fluid. The first reactive compartment V132 is one of the compartments V100 of the cell 100.

The second face 134 is oriented towards the second separator 120. The second separator 120 delimits with the membrane 130 a second reactive compartment V134, which is configured to receive a second working fluid of the fuel cell. Herein, the second reactive compartment V134 is e.g. a cathodic compartment of the single cell 100, meaning that the working fluid circulating in the compartment is air, which contains oxygen. Thus, the second working fluid is a gaseous fluid. The second reactive compartment V134 is another of the compartments V100 of the cell 100.

It is understood that when three single cells 100 are stacked on top of each other, with a bottom cell 100, a middle cell 100, and a top cell 100, the first separator 110 of the middle cell is adjacent to the second separator 120 of the top cell 100.

In the illustrated example, the first separator 110 of the middle cell 100 and the second separator 120 of the top cell delimit therebetween a first cooling compartment V136 of the middle cell 100.

The first cooling compartment V136 is thus common to two neighboring cells 100. The second separator 120 of the middle cell 100 and the first separator 110 of the bottom cell 100 delimit between them a second cooling compartment V138 of the middle cell. For two stacked single cells 100, the first cooling compartment V136 of the bottom cell is thus, for the top cell, a second compartment V138.

More generally, for the described cell 100, each cooling compartment V136 and V138 is configured to receive a third working fluid of the fuel cell 20. The third working fluid is herein a cooling fluid such as liquid glycolated water. Thus, the third working fluid is herein a liquid fluid at the operating temperatures of the cell 20. More generally, the first separator 110 is configured to separate in a sealed manner the first reactive compartment V132 from the first cooling compartment V136.

In the illustrated example, each single cell 100 thus comprises three compartments V100, namely the first reactive compartment V132, the second reactive compartment V134, and the first cooling compartment V136. Each of the compartments V100 is correspondingly associated with a working fluid of the fuel cell 20.

The fuel cell 20 houses herein, in each of the compartments V100 of the single cell 100, an irrigation spacer. More precisely, the second reactive compartment V134 houses an irrigation spacer 600 of a first type, according to a first embodiment, whereas the first reactive compartment V132 houses an irrigation spacer 700 of a second type, according to another embodiment. The first cooling compartment V136 also houses another example of the spacer 700 of the second type.

The irrigation spacers 600 or 700 are configured to define the circulation, within each compartment V100, of the corresponding working fluid. The irrigation spacers 600 and 700 are described further in the present description. When the cell 20 is assembled, the first separator 110, the second separator 120, the membrane 130, as well as the spacers 600 and 700, are bearing onto each other. Preferably, the gas diffusion layers 130B are stacked, along the axis of stacking 150, with axial clamping between an irrigation spacer 600 or 700 and the corresponding face of the membrane 130, so as to provide good electrical conduction between the stacked elements.

According to another aspect, the single cell 100 further comprises a sealing structure 200 (FIG. 5). The sealing structure comprises frames 210, each made of a polymer material and stacked along the axis of stacking A50. The frames 210 are arranged around the periphery of the walls 102 and of the compartments V100 of the single cell 100.

The principles of the sealing structure 200 are described using FIG. 5, where two walls 102 of the single cell 100, delimiting a single compartment V100, are represented. The wall 102 at the top of FIG. 5a) is herein the membrane 130, whereas the wall 102 at the bottom of FIG. 5a) is the second separator 120. The compartment represented is thus the second reactive compartment V134, knowing that the principles described can be transposed to the other compartments V100 of the single cell 100 and to the corresponding walls 102.

The rest of the single cell 100, in particular the irrigation spacer 600 or the diffusion layer 130B, is not represented in order to avoid overloading the figures which aim to represent more particularly the sealing structure. For the parts of the description which relate to the elements of the sealing structure 200, when two of the elements comprise surfaces facing each other and oriented orthogonally to the axis of stacking A50, the surfaces (and by extension the elements) are called “adjacent” to each other, whereas when the two surfaces are parallel to the axis of stacking A50, the surfaces are called “opposite” each other.

In the illustrated example, the frames 210 of the sealing structure 200 include wall frames 220, each wall frame 220 being coplanar with a respective wall 102 and surrounding the wall 102. In FIG. 5a), in order to facilitate the distinction between the parts, the wall frames 220 and the associated walls are represented offset, whereas in FIG. 5b), the wall frames 220 are represented coplanar with the respective walls 102, as in reality. Each wall frame 220 and the corresponding wall 102 are thereby opposite each other. Preferentially, each wall frame 220 has a thickness substantially equal, e.g. equal to ±10%, to a thickness of the corresponding wall 102, the thicknesses being measured parallel to the axis of stacking A50.

The frames 210 of the sealing structure 200 also include compartment frames 230. Each compartment frame 230 is arranged around the periphery of the corresponding compartment V100, herein the second reactive compartment V134. Only one compartment frame 230 is represented in FIG. 5. In the present embodiment of the sealing structure 200, each compartment frame 230 is formed of a one piece.

Each frame 210 of the sealing structure 200 has an overall ring shape, in the example a shape of rectangular ring, and is provided in a plate of a sealing material, e.g. by cutting. The wall frames 220 are made of an electrically insulating material, preferably a polymer material, e.g. polyethylene terephthalate, also called PET.

Each frame 210 comprises two faces 213, which are opposite each other and extend parallel to the median plane P50, an internal edge 214, which connects the two faces 213 to each other and is oriented towards an inner side of the single cell 100, and an external edge 215, which is opposite the internal edge 214 and connects the two faces 213 to each other. For each frame 210, the internal edge 214 defines, in projection onto the median plane P50, an internal contour of the frame 210, while the external edge 215 defines, in projection on the median plane P50, an external contour of the frame 210.

In the case of the wall frames 220, the internal edge 214 extends opposite the corresponding wall 102. In the case of the compartment frames 230, the internal edge 214 is oriented towards the corresponding compartment V100 and delimits the compartment V100 radially to the axis of stacking A50.

Similarly, each wall 102 comprises two faces 103 that are opposite each other and extend parallel to the median plane P50 and an external edge 105 that connects the two faces 103 to each other. For each wall 102, the corresponding external edge 105 is oriented towards the outside of the cell 100. The external edge 105 of each wall 102 defines, in projection onto the median plane P50, an external contour of the wall 102.

The internal edge 214 of each wall frame 220 is arranged opposite the external edge 105 of the associated wall 102, the internal edge 214 of the wall frame 220 and the external edge 105 of the opposite wall 102 being separated, radially to the axis of stacking A50, by a peripheral gap I220. Each wall 102 is thus associated with a peripheral gap I220 specific to the wall 102 and to the corresponding opposite wall frame 220. Consequently, each wall frame 220 is thus associated with a peripheral gap I220 specific to the wall frame 220 and to the corresponding opposite wall 102.

The peripheral gap I220 is as small as possible. The peripheral gap I220 is typically comprised between 0 mm (millimeter) and 0.2 mm. In reality, the peripheral gap I220 is not zero, in particular due to manufacturing tolerances and to the assembly clearances. In the illustrated example, I220 is equal to 0.1 mm.

The sealing structure 200 further comprises layers of adhesives 240, which are interposed between each of the frames 210 of the sealing structure so as to attach the frames to each other, in a sealed manner. Each layer of adhesive240 is thereby sandwiched between two frames 210 and is thus adjacent to each of the two frames 210. In the example shown in FIG. 5, two layers of adhesives 240 are represented, each layer of adhesive 240 being interposed in-between, on the one hand, the compartment frame 230 and, on the other hand, one of the walls 102 and the wall frame 220 associated with the wall 102. In other words, each layer of adhesive 240 is interposed in-between, on the one hand, the corresponding compartment frame 230 and, on the other hand, the wall 102 and the wall frame 220 which are adjacent to the compartment frame 230.

Each layer of adhesive 240 is made of a sealing material, preferably a “contact” type adhesive, also called PSA (in English) for “Pressure Sensitive Adhesive”. Advantageously, each layer of adhesive 240 can be repositionable, so that the sealing structure 200 is removable, the single cell 100 being by extension also removable. Non-limiting examples of adhesives include acrylic glues. Each layer of adhesive 240 is made of an electrically insulating material. Thus, the sealing structure 200, formed by the assembly of the frames 210 assembled to each other by layers of adhesives, provides not only the sealing between two neighboring compartments V100 but also the sealing and the electrical isolation of each compartment V100 with regard to the outside of the single cell.

Advantageously, each layer of adhesive240 extends continuously over the surfaces of the frames 210 and/or walls 102 that the layer of adhesive 240 secures. For example, for the assembly of two faces, the layer of adhesive 240 is applied by coating on one of the faces to be assembled, then the second face is pressed onto the layer of adhesive 240. In FIG. 5a), the two layers of adhesives 240 have a shape which is identical to the shape of the compartment frame 230 which is interposed between the two layers of adhesives 240. Preferably, the compartment frame 230 undergoes a coating with adhesive on each of the two opposite faces thereof before being cut and assembled to the rest of the sealing structure 240.

In the illustrated example, the compartment frame 230 is interposed, along the axis of stacking A50, between two walls 102, and between the two wall frames 220 that are coplanar with the two walls 102. The compartment frame 230 is thereby adjacent to the two wall frames 220.

For each of the walls 102 adjacent to the compartment frame 230, the internal contour of the compartment frame 230 is included, in projection along the axis of stacking A50, in an external contour of the adjacent wall 102, so that an annular portion of the wall 102 faces, along the axis of stacking 102, a mating portion of the compartment frame 230 and forms a first overlap S231 of the compartment frame 230 on the wall 102. Schematically, the first overlap S231 is a portion of a face 103 of the wall 102, which corresponds to the projection, parallel to the axis of stacking A50, of the compartment frame 230 onto the adjacent wall 102.

For each of the wall frames 220 associated with the walls 102 adjacent to the compartment frame 230, an internal contour of the wall frame 220 is included, in projection along the axis of stacking A50, in the external contour of the compartment frame 230, so that an annular portion of the wall frame 220 faces a mating portion of the compartment frame 230 and forms a second overlap S232 of the compartment frame 230 on the wall frame 220. The second overlap S232 corresponds to the projection, parallel to the axis of stacking A50, of the compartment frame 230 on the adjacent wall frame 220. Thereby, the second overlap 232 corresponds herein to the face 223 of the wall frame 220 that is oriented towards the considered compartment frame.

Preferably, the external contours of all the frames 210 of the sealing structure 200 are superimposed on each other along the axis of stacking A50, the external edges of all the frames of all the sealing structures forming together an external surface S100 of the single cell 100. The external surface S50 of the stack 50 corresponds to the union of the external surfaces S100 of the single cells 100 that compose the stack 50. Optionally, during the assembly of the stack 50, the external surface S50 is rectified after the assembly of the single cells 100, so that the external surface S50 is smooth.

For the layer of adhesive 240 interposed in-between the compartment frame 230 and the adjacent wall 102, the layer of adhesive 240 comprises a first portion, called the first portion of the layer 241, which extends opposite the first overlap S231 in-between the compartment frame 230 and the adjacent wall 102, so as to attach, in a sealed manner, the compartment frame 230 to the adjacent wall 102.

Similarly, the layer of adhesive 240 comprises a second portion, called the second portion of the layer 242, which extends opposite the second overlap S232 in-between the compartment frame 230 and the adjacent wall frame 220, so as to attach, in a sealed manner, the compartment frame 230 to the wall frame 220.

The first portion of the layer 241 and the second portion of the layer 242 are arranged in the same plane transverse to the axis of stacking A50. The first portion of the layer 241 is, in the transverse plane, surrounded by the second portion of the layer 242.

Advantageously, the layer of adhesive 240 comprises a third portion, called the third portion of the layer 243, which is interposed radially, in the same plane transverse to the axis of stacking A50, between the first portion of the layer 241 and the second portion of the layer 242 and thus unites the first portion of the layer 241 and the second portion of the layer 242 to each other. The third portion of the layer 243 of the layer of adhesive is located opposite, along the axis of stacking A50, the peripheral gap I220. The third portion of the layer 243 of the layer of adhesive 240 continuously links the first layer 242 to the second portion of the layer 242. In other words, the first portion of the layer 241 of adhesive and the second portion of the layer 242 of adhesive are part of the same continuous layer, herein the layer of adhesive 240 which extends over one face of the compartment frame 230, so as to cover the peripheral gap I220 opposite the compartment frame 230.

The first overlap S231 has a leak length L231 which is equal to a minimum distance, measured parallel to the median plane P50, between any two points belonging to the internal edge 214 of the corresponding compartment frame 230 and to the external edge 105 of the adjacent corresponding wall 102, respectively. In the example shown in FIG. 5, the leak length L231 is the length of the shortest path between the compartment V100 and the peripheral gap I220, passing between the compartment frame 230 and the adjacent wall 102 which were considered.

Similarly, the second overlap S232 has a leak length L232 which is equal to a minimum distance, measured parallel to the median plane P50, between any two points belonging to the external edge 215 of the corresponding compartment frame 230 and to the internal edge 214 of the adjacent corresponding wall frame 220, respectively. In the example shown in FIG. 5, the leak length L232 of the second overlap S232 is the length of the shortest path between the peripheral gap I220 and the outside of the single cell 100, passing between the compartment frame 230 and the adjacent wall frame 220 which were considered.

Each leak length L231 or L232 is greater than or equal to 1 mm, preferably greater than or equal to 2 mm, else preferably greater than or equal to 3 mm. A sealing greater than a minimum value is thereby provided, on the one hand, between each of the compartments V100 and the outside of the cell 100 and, on the other hand, between two neighboring compartments V100.

Preferably, the compartment frame 230 and the two associated layers of adhesives 240 are manufactured by coating an adhesive material on the two faces of the compartment frame 230, the compartment frame 230 thereby coated being then cut to the desired shape, before being assembled to the other elements of the single cell 100.

The assembly formed by the compartment frame 230 coated with the two associated layers of adhesives 240 thereby forms a so-called “double-sided adhesive frame.” The compartment frame 230 thereby forms a continuous and sealed core of the double-sided adhesive frame. Advantageously, during the manufacture of the single cell 100, a double-sided adhesive plate is provided, the double-sided adhesive plate comprising a continuous sealed core, herein of PET, coated on the two faces (sides) with an adhesive material. The adhesive material is, e.g. deposited using a coating method on the two faces of the core. The double-sided adhesive plate is then cut to the desired geometry, to form, in only one step, the compartment frame 230 and the two associated layers of adhesives 240.

Such a sealing structure 200 does not include any inlet or outlet passage for fluids in the associated compartment V100. If such an inlet and/or outlet for fluids needs to be provided in the compartment, it is necessary, with the sealing structure 200, to provide the inlet/outlet elsewhere, e.g. in one of the walls 102 that delimit the compartment.

A sealing structure 300, according to another embodiment, is shown in FIG. 6. The sealing structure 300 differs from the previously described sealing structure 200 in that the sealing structure 300 comprises a compartment frame that is produced in the form of a transfer frame 330 through which two passages 332 for fluids are provided, so as to let circulate therethrough the corresponding working fluid towards the compartment V100. Only one passage 332 for fluids is represented in FIG. 6. The transfer frames 330 are thus part of the frames 210. In the present embodiment of the sealing structure 300, each compartment frame 330 comprises only the transfer frame.

One of the two fluid passages 332 is an inlet for the working fluid, whereas the other passage 332 is an outlet for the working fluid, the notions of “inlet” and “outlet” depending on the direction of circulation of the working fluid. The passages 332 for fluids thereby connect the compartment V100 and the outside of the cell 100.

Preferably, the passages 332 for fluids are provided during the cutting of the transfer frame 330, the transfer frame 330 being sandwiched between the two layers of adhesives 240, to secure, in a sealed manner and with respect to the outside, the transfer frame 330 to the adjacent wall frames 220 and to the associated walls 102.

In an alternative not shown, a passage for fluids is formed by a partial recess, along the direction of the axis of stacking A50, of the transfer frame, such a recess having a depth along the stacking direction less than the thickness of the transfer frame, and a circumferential extent.

Each passage 332 opens into the associated compartment V100 through an internal mouth 334, which is provided on the internal edge 214 of the transfer frame 330. Each passage 332 opens to the outside of the compartment V100 through an external mouth 335. Each passage 332 thereby comprises an internal portion 334B, which opens through the internal mouth 334 into the corresponding compartment V100. The internal portion 334B of each passage 332 is provided in the thickness of the transfer frame 330. Such an arrangement thereby economically provides the passages 332 in each of the transfer frames 330, so as to feed each compartment V100 with the corresponding working fluid.

In the illustrated example, the external mouth 335 of each passage 332 of the transfer frame 330 is advantageously provided on the external edge 215 of the transfer frame 335, to fluidically communicate with one of the circulation conduits 38A, 38B, or 38C. One of the passages 332 of a transfer frame 330 thereby communicates with one of the circulation conduits 38A, 38B, or 38C, whereas the other passage 332 of the same transfer frame 330 communicates with the other of the circulation conduits 38A, 38B, or 38C that belongs to the same pair of conduits.

In other words, for each of the two passages 332 of the same transfer frame 330, the associated external mouth 335 of the passage 332 opens on the external edge 215 of the transfer frame 330 into a distinct conduit among the circulation conduits of the associated pair.

In an unillustrated variant, the external mouth 335 is arranged differently, e.g., axially oriented and arranged on one of the faces 213 of the transfer frame 330, the external mouths then being preferably aligned along the axis of stacking A50 to form chimneys which extend through the frames 210, the chimneys being intended for the circulation of the working fluids, repeating a known arrangement in the field of so-called “internal manifold” polar plates.

Advantageously, each passage 332 houses fins 336 for guiding the associated working fluid. Alternatively, only one of the two passages 332 comprises the fins 336. Within each passage 332 for fluids, the fins 336 form pillars, which maintain the two associated layers of adhesives 240 at a distance from the considered transfer frame 330. Two neighboring fins 336 delimit a channel therebetween. Each passage 332 for fluids is thus formed by the union of the channels delimited between the fins 336. The shape of each fin 336 is chosen to hinder as little as possible the flow of the working fluids passing through the passages 332, while making possible the transfer of mechanical clamping forces of the stack 50, the clamping forces being parallel to the axis of stacking A50.

The fins 336 are preferably formed, during the manufacture of the transfer frame 330, by cutting the transfer frame 330. The fins 336 thus have the same thickness as the rest of the transfer frame 330. When the cell 100 is assembled, the fins 336 are held by means of the layers of adhesives arranged on both sides of the considered transfer frame 330, herein the layers of adhesives 240, in-between which the transfer frame 330 is interposed. The fins 336 are advantageously spaced apart within the corresponding passage 332, so as to direct the flow of the associated working fluid. Preferably, the fins 336 are regularly distributed in the corresponding passage 332.

A sealing structure 400, according to another embodiment, is shown in FIG. 7. The sealing structure 400 differs from the previously described sealing structure 300 in that the sealing structure 400 comprises a compartment frame 430 that includes, in addition to the transfer frame 330 interposed between the two corresponding layers of adhesives 240, an additional frame, called the first sealing frame 432, which is interposed in-between the transfer frame 330 and one of the layers of adhesives 240 associated with the transfer frame 330. The first sealing frame 432 is thereby adjacent to a wall 102, to which the first sealing frame 432 is attached by one of the layers of adhesives 240. In other words, the first sealing frame 432 is interposed in-between, on the one hand, the transfer frame 330 and, on the other hand, one of the two walls 102 adjacent to the transfer frame 330. In the example shown in FIG. 7, the first sealing frame 432 is associated with the wall 102 and to the wall frame 220 located at the bottom of the FIG.

The compartment frame 430 further includes an adhesive film 440 which is interposed in-between the first sealing frame 432 and the transfer frame 330, so as to attach the transfer frame 330 to the adjacent first sealing frame 432.

Preferably, the adhesive film 440 is herein made of a sufficiently hard material, chosen to avoid the creeping of adhesives, in particular between the fins 336, under the effect of pressure, and thereby to avoid an obstruction of the passages 332 for fluids. The adhesive film 440 comprises herein i tabs 441, which correspond to the fins 336 of the transfer frame 330. The tabs 441 form herein a discontinuous portion of the adhesive film 440. In a variant (not shown), the adhesive film 440 does not comprise any tabs and is continuous along the circumferential direction about the axis of stacking A50, in the same way as the layers of adhesives 240.

The transfer frame 330, and more particularly the fins 336, are thereby attached to the first sealing frame 432 by the first adhesive film 440, whereas the first sealing frame 432 is attached in a sealed manner to the adjacent wall 102, and to the wall frame 220 opposite of the wall 102, by the corresponding layer of adhesive 240.

The sealing frame 432, which extends continuously, along the radial direction and along the circumferential direction about the axis of stacking A50, faces the peripheral gap I220 provided between the wall 102 and the opposite wall frame 210, thereby providing the layer of adhesive 240 a with a continuous support, which improves the sealing of the corresponding compartment V100 compared to the situation without the sealing frame 432. The presence of a sealing frame 432 is particularly advantageous in the case where the working fluid circulating in the compartment V100 is a gas, in other words, in the case where the transfer frame 330 is provided around the first reactive compartment V132 or around the second reactive compartment V134, where hydrogen and air, respectively, circulate.

Preferably, the sealing frame 432 has the same shape, in the sense of the same internal and external contour, as the transfer frame to which same belongs. Similarly, preferably, the adhesive film 440 has the same shape, in the sense of the same internal and external contour, as the first sealing frame 432 and as the corresponding transfer frame.

Thereby, the sealing frames 432 are preferably adjacent to the membrane 130, and to the wall frame opposite of the membrane 130, on the side where the working fluid is hydrogen, so as to prevent the risk of hydrogen pollution on the other side of the membrane 130. Else preferably, sealing frames 432 are arranged in each of the reactive compartments V132 and V134, on both sides of the membrane 130, so as to prevent transfers of gas between the two reactive compartments V132 and V134.

Preferably, the sealing frame 432 and the associated layer of adhesive 240 are manufactured by coating an adhesive material on one of the two faces of the sealing frame 432, the sealing frame 432 thereby coated being then cut to the desired shape, before being assembled with the other elements of the single cell 100.

The assembly formed by the sealing frame 432 coated with an associated layer of adhesive 240 thereby forms a so-called “single-sided adhesive frame.” The sealing frame 432 thereby forms a continuous and sealed core of the single-sided adhesive frame, the continuity being radial and circumferential. Advantageously, during the manufacture of the single cell 100, a single-sided adhesive plate is provided, the single-sided adhesive plate comprising a continuous sealed core, herein of PET, coated on one of the two faces (sides) thereof with an adhesive material. The adhesive material is e.g. deposited by coating on one of the faces of the core. The single-sided adhesive plate is then cut to the desired geometry, to form, in one step, the sealing frame 432 and the associated layer of adhesive 240, both being continuous both radially and circumferentially over the entire extent of the sealing frame 432.

A sealing structure 500, according to another embodiment, is represented in FIG. 8. The sealing structure 500 differs from the sealing structure 400 described hereinabove in that the sealing structure 500 comprises, for each transfer frame 330, two sealing frames 432, which are arranged on both sides of the transfer frame 330. The sealing structure 500 further comprises a second adhesive film 440, which is interposed in-between the second sealing frame 432 and the compartment frame 330.

Compared to the sealing structures 300 and 400 described previously with reference to FIGS. 6 and 7, in the case of the sealing structure 500 represented in FIG. 8, the surfaces of the adhesive films 440 oriented towards the fluid passages 332 are more reduced, which reduces the risk of pollution of the compartment V100 and the working fluid circulating in this compartment V100. The risk of obstruction of the fluid passages 332 by the creep of the adhesive films 442 is also reduced.

The first sealing frame 432 and the second sealing frame 432 are each interposed in-between, on the one hand, the transfer frame 330 and, on the other hand, one of the two respective layers of adhesives 240. The second sealing frame 432 is, on the one hand, attached to the wall 102 and to the corresponding wall frame 210 by the corresponding layer of adhesive 240 and, on the other hand, attached to the transfer frame 330 by means of the second adhesive film 440. In other words, in the present embodiment of the sealing structure 500, the transfer frame 330, the two sealing frames 432, and the two adhesive films 440 together form a compartment frame 530 of the sealing structure.

Advantageously, for each of the two sealing frames 432, the associated layer of adhesive 240 is coated on the sealing frame 432, so as to form a single-sided adhesive frame. During manufacture, each frame 432 and the associated layer of adhesive 240 are formed during the same steps, by cutting a single-sided adhesive plate.

It is understood that for each wall 102 of the single cell 100, when the compartments located on each side of the wall 102 comprise transfer frames 330 sandwiched between two adhesive films 440, it is particularly advantageous to seal the gap I220, using a sealing frame 432 and an associated layer of adhesive 240, on at least one of the faces 103 of the wall 102, as the adhesive films 440 may not be sufficient to guarantee sufficient sealing. When the wall 102 is the membrane 130, the membrane 130 is preferably sealed on each of the two faces thereof by a sealing frame 432 with the associated layer of adhesive 240, so as to maintain the membrane 130, which is herein made of fluorinated polymer and is more fragile and more difficult to bond than the separators 110 and 120, which are herein made of stainless steel.

In the example shown in FIG. 8, the considered compartment V100 is delimited by two sealing frames 432 and by the associated layers of adhesives 240, further improving the sealing of the frame V100. More particularly, the compartment V100 where the working fluid is hydrogen is preferably delimited by such a sealing structure comprising two sealing frames 432 on both sides of the compartment frame 330.

Else preferably, all the compartments V100 where gases circulate, herein the first reactive compartment V132 and the second reactive compartment V134, are each delimited by two sealing frames 432 on either side of a compartment frame 330 associated with this reactive compartment.

FIG. 9 illustrates, for a considered compartment V100, respectively, on inserts a) and b), two alternative sealing structures 500′ and 500″ of the sealing structure 500 represented in FIG. 8.

Compared to the sealing structure 500 represented in FIG. 8, in the case of the sealing structure 500′ represented in FIG. 9a), one of the sealing frames 432 and the associated layer of adhesive 240 of the sealing frame 432 are arranged on the other side of one of the walls 102 delimiting the compartment V100, herein on the other side of the wall 102 located at the bottom of FIG. 9a), the sealing frame 432 thus belonging, in a stack, to the compartment frame of the neighboring compartment of the considered compartment V100, located on the other side of the wall 102 located at the bottom of FIG. 9a). The associated layer of adhesive 240 of the wall 102 is thus interposed, on the other side of the wall 102 relative to the considered compartment V100, in-between the sealing frame 432 and the wall 102, for sealing the gap I220. The gap I220 is not represented in FIG. 9.

Compared to the sealing structure 500 represented in FIG. 8, in the case of the sealing structure 500″ represented in FIG. 9b), the two sealing frames 432 and the associated layers of adhesives 240 of each of the sealing frames 432 are arranged on the other side of the two walls 102 delimiting the compartment V100. In other words, the transfer frame 330 associated with the compartment V100 of FIG. 9b) is interposed in-between the two wall frames 220 that immediately frame same in the direction of stacking A50, without the interposition of any sealing frame between the transfer frame 330 and the two wall frames 220. However, such sealing frames 432 are provided immediately in contact with each of the two wall frames 220 with, for each wall frame, only the interposition of a layer of adhesive 240 in-between the sealing frame 432 and the wall frame. In a stack, the two sealing frames 432 thus each belong correspondingly to one of the two compartment frames of the two neighboring compartments of the considered compartment V100, located on the other side of the wall 102 located at the bottom of FIG. 9b) and on the other side of the wall 102 located towards the top of FIG. 9b), respectively.

In all cases where the compartment frame comprises a sealing frame 432, and in particular in all cases where the sealing frame 432 is interposed between a transfer frame 330, belonging to the same compartment frame, and a wall frame 220, the layer of adhesive 240, which is thus interposed in-between, on the one hand, the sealing frame, and, on the other hand, the wall 102 and the wall frame 220 associated with the wall, necessarily includes a first portion of layer, which extends opposite the first overlap between the compartment frame (herein the sealing frame being part of the compartment frame) and the wall, so as to attach, in a sealed manner, the compartment frame to the wall. The first portion of the layer 241 is thus in such cases opposite and in contact with the sealing frame 432 and the wall. The same layer of adhesive 240 includes the second portion of the layer 242, which extends opposite the second overlap between the compartment frame (herein again the sealing frame being part of the compartment frame) and the wall frame, so as to attach, in a sealed manner, the compartment frame to the wall frame. The second portion of the layer 242 is thus in such cases opposite and in contact with the sealing frame 432 and the wall frame 220. Of course, the first portion of the layer 241 of adhesive and the second portion of the layer 242 of adhesive are preferably part of the same layer of adhesive 240, as in the illustrations, which extends continuously over one face of the compartment frame, in the present case, a face of the sealing frame 432, the two first and second portions of the layer of adhesive 241 and 242 thus being continuous both radially and circumferentially over the entire extent of the sealing frame 432, so as to close the peripheral gap I220 opposite the compartment frame 220.

The sealing structures 500, 500′, and 500″ represented in FIGS. 8 and 9 can thus be chosen, according to needs, for each of the compartments V100 of a single cell 100, and, by extension, for the stack 50.

In general, the thicknesses of each element of the sealing structures 200, 300, 400, or 500, namely the thicknesses of the wall frames 220, of the compartment frames 220, of the transfer frames 330, of the sealing frames 432, as well as the thicknesses of the layers of adhesives 240 or of the adhesive films 440, are adjusted according to the structure of each single cell 100, more particularly according to the nature of each wall 102 and to the various elements received in each of the compartments V100 of the single cell 100.

Thus, each sealing frame 432 is made of a polymer material, e.g. PET, and has a thickness, measured parallel to the axis of stacking A50, comprised between 10 μm and 20 μm, preferably equal to 12 μm.

The adhesive film 440 interposed in-between each sealing frame 432 and the corresponding transfer frame 330 has a thickness, measured parallel to the axis of stacking A50, comprised between 6 μm and 30 μm, preferably comprised between 8 μm and 20 μm, preferably comprised between 10 μm and 15 μm.

Each transfer frame 330 is made of a polymer material, e.g. PET, and has a thickness, measured parallel to the axis of stacking A50, comprised between 50 μm and 600 μm, preferably comprised between 80 μm and 150 μm, preferably equal to 100 μm.

For each layer of adhesive 240, the first portion of the layer and the second portion of the layer each have a thickness, measured parallel to the axis of stacking, comprised between 15 μm and 30 μm, preferably comprised between 18 μm and 25 μm, preferably equal to 20 μm. Preferably, the thickness is identical for the first portion of the layer and the second portion of the layer.

The single cell 100 is schematically represented in section in FIG. 10. As indicated in dotted lines, the single cell is repeated in the stack.

The first reactive compartment V132 houses herein an example of the spacer 700 of the second type. At the periphery of the first reactive compartment V132, the frames 210 that form the compartment frame corresponding to the compartment comprise a transfer frame 330, which provides the two passages 332 associated with the first reactive compartment V132, and two sealing frames 432, one on each side of the transfer frame 330, which are each attached to the transfer frame 330 by a respective adhesive film 440.

The second reactive compartment V134 houses herein an example of the spacer 600 of the first type. At the periphery of the second reactive compartment V134, the frames 210 that form the compartment frame corresponding to the reactive compartment V134 comprise a transfer frame 330, which provides the two passages 332 associated with the second reactive compartment V132, and two sealing frames 432, one on each side of the transfer frame 330, which are each attached to the transfer frame 330 by a respective adhesive film 440.

The cooling compartment V136 houses herein a second example of the spacer 700 of the second type. At the periphery of the cooling compartment V136, the frames 210 that form the compartment frame corresponding to the compartment comprise only a transfer frame 330, which provides the two passages 332 associated with the cooling reactive compartment V132.

It is noted, however, that a given sealing structure can be used regardless of the type of spacer contained in a given compartment.

In FIG. 10, the passages 332 are schematically represented by dotted arrows. More particularly, the passages 332 for each of the compartments V132, V134, and V136 are represented as if same were aligned along the axis of stacking A50, the illustration being schematic. As seen in FIG. 4, the location and the extent along the circumferential direction of the passages 332 are adjusted according to the type and to the orientation of the irrigation spacers 600 or 700. Preferably, as illustrated in FIG. 4, the passages 332 for each of the compartments V132, V134, and V136 of the same single cell 100 are offset from each other on the perimeter of the cell, preferably being substantially diametrically opposite each other. On the other hand, the passages 332 of each of the first reactive compartments V132 of all the single cells 100 of the stack are preferably aligned along the axis of stacking A50. Similarly, the passages 332 of each of the second reactive compartments V134 of all the single cells 100 of the stack are preferably aligned along the axis of stacking A50, and the passages 332 of each of the cooling compartments V136 of all the single cells 100 of the stack are preferably aligned along the axis of stacking A50.

In the example shown in FIG. 10, the first reactive compartment V132 and the second reactive compartment V134 are each delimited by a compartment frame comprising two respective sealing frames 432, arranged on both sides of a transfer frame 300, each sealing frame 432 being adjacent to a respective wall 102. Thereby, the peripheral gap I220 associated with the wall 102 separating the two reactive compartments V132 and V134, in other words, the gap I220 associated with the membrane 130, is sealed, on both faces of the membrane 130, by a respective sealing frame 432. For each compartment frame of the first reactive compartment V132 and of the second reactive compartment V134, each sealing frame 432 is attached to the transfer frame by an adhesive film 440. The compartment frame thereby formed is associated with two layers of adhesives 240 arranged on both sides of the compartment frame along the axis of stacking A50. Each of the two layers of adhesives 240 is thus interposed in-between, on the one hand, a sealing frame 432, and, on the other hand, the wall 102 and the wall frame 220 associated with the wall.

In the example shown in FIG. 10, the cooling compartment V136 is delimited by a compartment frame comprising only a transfer frame 330, without a sealing frame 432. Thereby, the peripheral gap I220 associated with the first separator 110 is sealed by a sealing frame 432 only on one side of the first separator 110, and the sealing frame 432 belonging to the compartment frame of the neighboring compartment, herein to the first reactive compartment V132. Similarly, by means of the pattern effect due to the stacking of identical cells, the peripheral gap I220 associated with the second separator 120 is sealed by a sealing frame 432 only on one side of the first separator 110, the sealing frame 432 belonging to the compartment frame of the first reactive compartment V132. Of course, to make the sealing secure, one could have provided, for the cooling compartment V136, a compartment frame comprising a sealing frame on one side of the transfer frame 330, or comprising two sealing frames, on each side, of the transfer frame 330.

A single cell 200 according to an alternative embodiment is shown in FIG. 11. The single cell 200 comprises the first reactive compartment V132 and the second reactive compartment V134, but does not comprise any cooling compartment. The cooling of the single cell 200 is herein provided by the passage of air, which circulates herein in the second reactive compartment V134.

Unlike the single cell 100 of the preceding embodiment, the second reactive compartment V134 is herein delimited by a compartment frame comprising only one sealing frame 432. In the example shown in FIG. 11, the peripheral gap I220 associated with the membrane 130 is sealed on one side by a sealing frame 432. To compensate for the absence of the sealing frame without reducing the height of the compartment, the transfer frame 330 received in the second reactive compartment has herein a greater thickness than the transfer frame 330 of the preceding embodiment, so that the passage 332 for fluids lets through a higher flow rate of the associated working fluid-herein, air-which serves both for the electrochemical reaction of the fuel cell and for the cooling of the cell.

Regardless of the number of compartments V100 of the single cell 100, with or without a cooling compartment V136, for each compartment V100, and for each of the walls 102 delimiting the compartment V100, the peripheral gap I220 associated with the wall 102 is sealed, on at least one of the faces of the wall 102, by a sealing frame 432, which is attached to the wall by the associated layer of adhesive 240. In other words, the peripheral gap I220 associated with the wall 102 is sealed, on at least one of the faces of the wall, by a continuous frame over the entire circumference of the gap I220.

Preferably, the reactive compartment where hydrogen circulates, herein the first compartment V132, is delimited by a compartment frame comprising two sealing frames 432 arranged on both sides of a transfer frame 330 along the axis of stacking A50, each of the sealing frames 432 sealing a peripheral gap I220 associated with the two walls 201 delimiting the reactive compartment. Each sealing frame is attached to the transfer frame by an adhesive film 440. The compartment frame thereby formed is associated with two layers of adhesives 240 arranged on both sides of the compartment frame along the axis of stacking A50. Each of the two layers of adhesives 240 is thus interposed in-between, on the one hand, a sealing frame 432, and, on the other hand, the wall 102 and the wall frame 220 associated with the wall.

Preferably, each sealing frame 432 and the associated layer of adhesive 240 are made by cutting from a single-sided adhesive sheet.

Preferably, each transfer frame 330 and the two associated adhesive films 440 are made by cutting from a double-sided adhesive sheet.

The irrigation spacer 600 of the first type is now described using FIGS. 12 and 13.

The irrigation spacer 600, also simply called “spacer 600”, has an overall rectangular shape, with two large opposite sides and two small opposite sides, and flat, which extends orthogonally to a height axis A600. When the spacer 600 is received in the corresponding compartment V100, the height axis A600 is parallel to the axis of stacking A50. The large sides extend parallel to a longitudinal axis X600 of the spacer 600, whereas the small sides extend parallel to a transverse axis Y600 of the spacer 600. The longitudinal axis X600, the transverse axis Y600, and the height axis A600 form together an orthogonal reference frame.

The spacer 600 comprises two distribution plates 602, including a first plate 602A and a second plate 602B. The distribution plates 602 each comprise two opposite faces, including a first face 604 and a second face 605.

The two plates 602 are stacked flat on top of each other along the height axis A600 which is orthogonal to a median plane P600 of the irrigation spacer 600. When the spacer 600 is received in the compartment V100, the median plane P600 of the irrigation spacer 600 is thus orthogonal to the axis of stacking A50, or parallel to the median plane P50 of the corresponding single cell 100.

Each distribution plate 602 is manufactured by cutting from a metal sheet and has a thickness comprised between 30 μm and 300 μm, preferably comprised between 50 μm and 100 μm, else preferably equal, within +5%, to 75 μm. Preferably, the distribution plates 602 have the same thickness.

Each distribution plate 602 comprises perforations 610, which are formed by cutting the distribution plate 602. The perforations 610 are through, meaning that the perforations 610 open onto both opposite faces 604 and 605 of the distribution plate 602.

The perforations 602 are arranged to form a network 612 of channels when the two plates 602 are stacked, the network 612 of channels being configured to form a flow field of an operating fluid circulating in the compartment V100 where the irrigation spacer 600 is housed.

The irrigation spacer 600 comprises an inlet 613A for fluids and an outlet 613B for fluids, the inlet 613A and the outlet 613B being fluidically connected to each other by the network of channels 612. The notions of “inlet” and “outlet” are relative and depend on the direction of flow of the flowing fluid. In the illustrated example, the inlet 613A and the outlet 613B are correspondingly arranged on the small sides of the spacer 600.

The perforations 610 of each distribution plate 602 have an elongated shape, two neighboring perforations 610 extending along each other and being separated from each other by a strip 614 of material. Each perforation 610 is delimited by two opposite longitudinal edges 616, each of the two longitudinal edges 616 corresponding to one edge of the two strips 614 of material that delimit each perforation 610.

Each distribution plate 602 further comprises crosspieces 618, which extend across the perforations 610, in the thickness of the distribution plate 602, and which maintain the strips 614 at a distance from each other. Each crosspiece 618 thereby links the two longitudinal edges 616 of the perforation 610 through which the crosspiece 618 extends.

Each strip 614 of the first plate 602A is superimposed, along the height axis A600, with a respective strip 614 of the second plate 602B, delimiting a first portion 620 of the network 612 of channels. In other words, in the first portion 620 of the network 612 of channels, each perforation 610 of the first plate 602A is aligned, along the height axis A600, with a respective perforation 610 of the second plate 602B, so as to form each channel of the network 612. The irrigation spacer 600 herein comprises only one portion 620, in other words, the first portion 620 represents the entirety of the network 612 of channels. The first portion 620 of the network 612 is represented by a dotted frame.

To the first portion 620 of the network 612 of channels corresponds, on each of the distribution plates 602, a first portion 621 of the distribution plates 602. For each distribution plate 602 of the irrigation spacer 600 of the first type, the first portion 621 of the plate 602 thus represents the entirety of the plate.

The crosspieces 618 of the first plate 602A are offset, in the median plane P600 of the spacer 600, relative to the crosspieces 618 of the second plate 602B, so as not to impede the circulation of the working fluids in the channels of the first portion 620 of the network 612 of channels of the irrigation spacer 600.

In insert c) of FIG. 13, a detail of the spacer 600 is shown sandwiched in-between two elements of the cell 100, namely between the membrane 130 and the second separator 120. The circulation of the working fluid is represented by an arrow F 612. It is understood that the fluid circulating in each channel of the network 612 flows along each channel while bypassing the crosspieces 618, which are offset from each other along the direction of the channel, two crosspieces 618 of the spacer 600, which extend across a given channel and do not belong to the same distribution plate 602, being thus offset from each other along the direction of the channel.

In the first portion 620 of the network of channels, the strips 614 of each distribution plate 602 are preferably parallel to each other. As a result, the perforations 610, and thus the channels of the network 612, are also parallel to each other, so as to reduce the pressure drops of the working fluid circulating in the spacer 600.

Advantageously, for each of the distribution plates 602 for the irrigation spacer 600 of a given compartment, each strip 614 of material extends continuously from the fluid inlet 613A to the fluid outlet 613B of the spacer 600, so that each channel of the network 612 extends continuously from the inlet 613A to the outlet 613B. In other words, there is no bifurcation or junction of the perforations 610, so as to reduce the pressure drops of the working fluid circulating in the spacer 600.

Preferably, in the first portion 620 of the network 612 of channels, the strips 614 of the irrigation spacer 600 are rectilinear in orthogonal projection on the median plane P600 of the spacer 600. Thereby, the channels of the first portion of the network of channels are rectilinear.

Preferably, in the first portion 620 of the network 612 of channels, the perforations 610 each have the same width 1610, which is comprised between 0.2 mm and 1.1 mm, whereas the strips 614 of material separating two neighboring perforations 610 each have a width 1614 comprised between 0.2 mm and 0.7 mm. Thereby is achieved both a good flow of the working fluid and a good transfer of compression forces, parallel to the height axis A600, which are exerted on the spacer 600 when the spacer 600 is received in a fuel cell 20.

Preferably, in the first portion 620 of the network 612 of channels, each crosspiece 618 has a height equal to a height of the strips 614 of material adjacent to the perforation 610 wherein the crosspiece 618 is arranged, the height of the crosspieces and the height of the strips being measured parallel to the height axis. The manufacturing process is thus simplified, each distribution plate 602 being produced by simple cutting.

The irrigation spacer 700 of the second type is now described using FIGS. 14 and 15. The elements identical to the elements of the irrigation spacer 600 of the first type have the same references.

While for the spacer 600 of the first type, each channel of the network 612 of channels is rectilinear from end to end, i.e. from the inlet 613A to the outlet 613B, the spacer 700 of the second type comprises a network of channels 712, wherein each channel is formed of a plurality of rectilinear portions, two consecutive portions not being aligned with each other.

The spacer 700 comprises an inlet 713A and an outlet 713B, which are each provided on one of the respective large sides of the rectangle. Advantageously, each channel of the network 712 extends continuously from the inlet 713A to the outlet 713B.

The network 712 of channels comprises a plurality of distinct portions. Within each portion, the perforations 610 are parallel to each other, two adjacent perforations 610 being separated from each other by a respective strip 614 of material.

In the illustrated example, the network 712 of channels comprises three consecutive portions, including a first portion 714A, a second portion 714B, and a third portion 714C, the contours of the three portions 714A, 741B, and 714C being shown in dotted lines on FIGS. 14 and 15. More generally, the number of portions is chosen according to the geometry of the spacer, the layout of the inlet for fluids and of the outlet for fluids, etc. What is valid for the first and second portions 714A and 714B of the network 712 of channels is transposable to any two consecutive portions of the network 712 of the network of channels.

The spacer 700 comprises two distribution plates 702, including a first plate 702A and a second plate 702B. The portions 714A, 714B, and 714C of the network 712 of channels are found, with the references 724A, 724B, and 724C, on each of the plates 702. In FIG. 14, only the first and second portions 724A and 724B of each of the first and second distribution plates 702A and 702B are visible. The operating principle of the spacer 700 is described with reference to the first and second portions 714A and 714B of the network 712 of channels.

For each of the first and second distribution plates 702A and 702B, in each of the first and second portions 724A and 724B, the perforations 610 are parallel to each other, two adjacent perforations 610 being separated from each other by a respective strip 614 of material.

Each strip 614 of the second portion 724B of the first plate 702A is superimposed, along the height axis A600, with a respective strip 614 of the second portion 724B of the second plate 702B, so as to form channels of a second portion 714B of the network 712 of channels of the irrigation spacer 700, the channels of the second portion 714B of the network 712 of channels being parallel to each other.

For each distribution plate 702A or 702B, each strip 614 of the first portion 724A of the distribution plate extends continuously with a strip 614 of the second portion 724B of the same distribution plate.

For each distribution plate 702A or 702B, the strips 614 of the first portion 724A are rectilinear and parallel to each other, the channels of the first portion 714A of the network 712 extending along a first flow axis 716A, whereas the strips 614 of the second portion 724B are rectilinear and parallel to each other, the channels of the second portion 714B of the network 712 extending along a second flow axis 716B. The first flow axis 716A and the second flow axis 716B are each represented by a respective arrow in FIGS. 14 and 15. The first flow axis 716A is herein parallel to the transverse axis Y600, whereas the second flow axis 716B is herein parallel to the longitudinal axis X 100.

The first flow axis 716A and the second flow axis 716B are distinct, meaning that the working fluid circulating in each channel of the network 712 changes direction when passing from the first portion 714A to the second portion 714B.

The first flow axis 716A and the second flow axis 716B form an angle between 1 and 179°, preferably comprised between 30°and 150°, else preferably comprised between 60°and 120°. In the illustrated example, the first flow axis 716A and the second flow axis 716B form therebetween an angle equal to 90°.

In the illustrated examples, each of the compartments among the first reactive compartment V132, the second reactive compartment V134, and the first cooling compartment V126 houses an irrigation spacer 600 or 700 according to the invention.

In a variant not shown, only one of the housings V100 of the single cell 100 receives an irrigation spacer of another type, the other two housings V100 each receiving an irrigation spacer according to the invention. According to another variant not shown, only one of the housings V100 of the single cell 100 receives an irrigation spacer according to the invention, the other two housings V100 each receiving an irrigation spacer of another type.

The embodiments and variants mentioned hereinabove can be combined with each other to generate new embodiments of the invention.

1-18. (canceled)

19. A single cell of a stack of a fuel cell, wherein:
the single cell comprises a plurality of walls, which are each continuous and sealed and which are stacked on top of each other along an axis of stacking, the walls delimiting compartments of the single cell and include:
a first separator,
a second separator, and
a proton exchange membrane, which is interposed in-between the first separator and the second separator,
the first separator delimits with the membrane a first reactive compartment, the first reactive compartment being configured to receive a first working fluid of the fuel cell,
the second separator delimits with the membrane a second reactive compartment, the second reactive compartment being configured to receive a second working fluid of the fuel cell,
the compartments of the single cell include the first reactive compartment and the second reactive compartment,
the cell further comprises a sealing structure, the sealing structure comprising frames, which are each made of a polymer material and which are stacked along the axis of stacking, the frames being arranged at the periphery of the walls and of the compartments,
wherein, for at least one of the compartments of the single cell, and for at least one of the two walls delimiting the at least one compartment:
the frames of the sealing structure include:
a wall frame, which is coplanar with the corresponding wall and which surrounds the wall, an internal edge of each wall frame being arranged opposite an external edge of the wall, the internal edge of the wall frame and the external edge of the wall being opposite each other and being separated by a peripheral gap, each wall frame having a thickness equal to a thickness of the corresponding wall,
a compartment frame, which is arranged at the periphery of the corresponding compartment, the compartment frame comprising an internal edge, which is oriented towards the corresponding compartment and which delimits the compartment radially to the axis of stacking, and an external edge, opposite the internal edge, the internal edge having an internal contour, whereas the external edge has an external contour,
layers of adhesives, which are each interposed in-between, on the one hand, a compartment frame, and, on the other hand, the wall and the wall frame adjacent to the compartment frame, so as to attach, in a sealed manner, the frames to each other,
the internal contour of the compartment frame is included, in projection along the axis of stacking, in an external contour of the wall, so that an annular portion of the wall faces, along the axis of stacking, a mating portion of the compartment frame and forms a first overlap of the compartment frame on the wall,
an internal contour of the wall frame is included, in projection along the axis of stacking, in the external contour of the compartment frame, so that an annular portion of the wall frame faces a mating portion of the compartment frame and forms a second overlap of the compartment frame on the wall frame,
the layers of adhesives include a first portion of layer, which extends opposite the first overlap between the compartment frame and the adjacent wall, so as to attach, in a sealed manner, the compartment frame to the wall, and
the layers of adhesives include a second portion of layer, which extends opposite the second overlap between the compartment frame and the adjacent wall frame, so as to attach, in a sealed manner, the compartment frame to the wall frame.

20. The single cell according to claim 19, wherein:
the first separator is configured to separate in a sealed manner the first reactive compartment from a first cooling compartment, which is configured to receive a third working fluid of the fuel cell,
the compartments of the single cell include, in addition to the first reactive compartment and the second reactive compartment, the first cooling compartment.

21. The single cell according to claim 19, wherein the first portion of layer of adhesive and the second portion of layer of adhesive are part of the same layer of adhesive, which extends continuously on one face of the compartment frame, so as to close the peripheral gap adjacent to the compartment frame.

22. The single cell according to claim 19, wherein:
the first overlap has a leak length, which is equal to a minimum distance, measured parallel to the median plane, between any two points belonging to the internal edge of the corresponding compartment frame and to the external edge of the corresponding adjacent wall, respectively,
the second overlap has a leak length, which is equal to a minimum distance, measured parallel to the median plane, between any two points belonging to the external edge of the corresponding compartment frame and to the internal edge of the corresponding adjacent wall frame, respectively
each leak length is greater than or equal to 1 mm.

23. The single cell according to claim 19, wherein, for at least one of the compartment frames:
the compartment frame includes a transfer frame which provides two passages for fluids, the two passages being provided for the circulation of the associated working fluid between the corresponding compartment and the outside of the single cell,
each passage opens into the associated compartment through an internal mouth, which is provided on the internal edge of the transfer frame, and
each passage opens to the outside of the compartment through an external mouth.

24. The single cell according to claim 23, wherein:
each passage comprises an internal portion, which opens through the internal mouth into the compartment, the internal portion of the passage being provided in the thickness of the transfer frame.

25. The single cell according to claim 23, wherein the external mouth is provided on the external edge of the transfer frame.

26. The single cell according to claim 23, wherein, for at least one transfer frame:
at least one of the two passages houses fins for guiding the associated working fluid,
the fins are formed by cutting the transfer frame and are spaced apart from each other within the corresponding passage, so as to direct the flow of the associated working fluid,
the fins are maintained by means of the layers of adhesives in-between which the corresponding transfer frame is interposed.

27. The single cell according to claim 23, wherein,
for at least one of the first and second reactive compartments, the compartment frame comprises:
the transfer frame,
a first sealing frame, which is interposed in-between, on the one hand, the transfer frame and, on the other hand, a first of the two walls adjacent to the compartment frame and the wall frame opposite the first wall,
a first adhesive film, which is interposed in-between the first sealing frame and the transfer frame,
the first sealing frame is, on the one hand, attached to the first wall and to opposite the wall frame by the associated layer of adhesive and, on the other hand, attached to the transfer frame by the first adhesive film.

28. The single cell according to claim 23, wherein, for at least one transfer frame:
this transfer frame is made of a polymer material, and has a thickness, measured parallel to the axis of stacking, comprised between 50 μm and 200 μm,
each of the first portion of layer of adhesive and each of the second portions of layer of adhesive has a thickness, measured parallel to the axis of stacking, comprised between 15 μm and 30 μm.

29. A fuel cell, comprising a stack formed of a plurality of single cells stacked along the axis of stacking, each single cell being according to claim 19, and a sleeve, which provides an internal volume wherein the stack is housed, wherein:
the frames of the sealing structure of each single cell each have their own external edge, with an associated external contour,
the external contours of all the frames of each sealing structure are superimposed on each other along the axis of stacking, the external edges of all the frames of all the sealing structures forming together an external surface of the stack, which has a cylindrical shape centered on the axis of stacking,
the external surface of the stack provides holding members, which are configured to cooperate with mating members provided in the internal volume of the sleeve, so as to maintain the stack within the internal volume and to provide a peripheral volume between the stack and the sleeve, and
the holding members and the mating members are designed to divide the peripheral volume into a plurality of conduits for the circulation of the working fluids of the fuel cell.

30. The fuel cell according to claim 29, wherein:
for each compartment of each single cell, the associated compartment frame includes a transfer frame which provides two passages for fluids, the two passages being provided for the circulation of the associated working fluid between the corresponding compartment and the outside of the single cell,
each passage opens into the associated compartment through an internal mouth, which is provided on the internal edge of the transfer frame, and
each passage opens to the outside of the compartment through an external mouth.

31. The fuel cell according to claim 30, wherein:
the external mouth is provided on the external edge of the transfer frame,
the fuel cell provides two first pairs of circulation conduits, which are associated with the first and second working fluids of the fuel cell, respectively
for each single cell:
each of the two compartments chosen from the first reactive compartment and the second reactive compartment, is associated with a respective pair of the first conduits,
the compartment frames associated with each of the two reactive compartments of the single cell each comprise a transfer frame with two passages each, the external mouth of each passage being provided on an external edge of the corresponding transfer frame,
the two passages of the same transfer frame each open into a distinct conduit among the two circulation conduits of the associated pair of conduits.

32. The fuel cell according to claim 31, wherein:
for each single cell, the first separator is configured to separate in a sealed manner the first reactive compartment from a first cooling compartment, which is configured to receive a third working fluid of the fuel cell,
the fuel cell provides, in addition to the two first pairs of circulation conduits, a third pair of circulation conduits, the circulation conduits of the third pair being associated with the third working fluid,
for each single cell:
each of the three compartments chosen from the first reactive compartment, the second reactive compartment, and the first cooling compartment, is associated with a respective pair among the three pairs of conduits,
the compartment frames associated with each of the three compartments of the single cell each comprise a transfer frame with two passages each, the external mouth of each passage being provided on an external edge of the corresponding transfer frame,
the two passages of the same transfer frame each open into a distinct conduit among the two circulation conduits of the associated pair of conduits.
